(19) United States
(12) Patent Application Publication
(10) Pub. No.: US 2015/0098046 A1
(43) Pub. Date: Apr. 9, 2015

(54) POLARIZING PLATE PROTECTIVE FILM, POLARIZING PLATE, LIQUID CRYSTAL DISPLAY DEVICE, AND PRODUCTION METHOD OF POLARIZING PLATE PROTECTIVE FILM

(71) Applicant: FUJIFILM Corporation, Tokyo (JP)

(72) Inventors: Kenichi FUKUDA, Kanagawa (JP); Naoya SHIBATA, Kanagawa (JP)

(73) Assignee: FUJIFILM CORPORATION, Tokyo (JP)

(21) Appl. No.: 14/509,735

(22) Filed: Oct. 8, 2014

(30) Foreign Application Priority Data
Oct. 9, 2013 (JP) 2013-212190
Aug. 21, 2014 (JP) 2014-168615

(51) Int. Cl. G02B 5/30; C09D 135/02; G02F 1/1335; G02B 1/10

(52) U.S. Cl. CPC G02B 5/3033; G02B 1/105; G02B 5/3025; C09D 135/02; G02F 1/133528
USPC 349/96; 524/363; 428/507

(57) ABSTRACT

There is provided a polarizing plate protective film having, on a substrate film, a layer formed by curing a curable composition containing, setting a total solid content of the curable composition to 100 mass %, from 50 to 99 mass % of the following (A) and from 1 to 30 mass % of the following (B) based on the total solid content: (A) at least either a compound having a cyclic aliphatic hydrocarbon group and an ethylenically unsaturated double bond or a compound having a fluorene ring and an ethylenically unsaturated double bond; and (B) a compound having, in the molecule, at least one of a benzene ring and a cyclohexane ring, and at least one of a hydroxyl group and a carboxy group and the (B) is defined as herein.

### CROSS-REFERENCE TO RELATED APPLICATIONS

This application claims priority from Japanese Patent Application No. 2013-212190, filed on Oct. 9, 2013 and Japanese Patent Application No. 2014-168615 filed on Aug. 21, 2014, the contents of all of which are hereby incorporated by reference in their entirety.

### BACKGROUND OF THE INVENTION

1. Field of the Invention

The present invention relates to a polarizing plate protective film, a polarizing plate, a liquid crystal display device, and a production method of a polarizing plate protective film.

2. Description of the Related Art

In recent years, a liquid crystal display device is widely used in applications such as liquid crystal panel of a liquid crystal television, cellular phone and digital camera. Usually, the liquid crystal display device has a liquid crystal panel member fabricated by providing a polarizing plate on both sides of a liquid crystal cell, and display is performed by controlling light from a backlight member by the liquid crystal panel member. Here, the polarizing plate consists of a polarizer and a protective film therefor, where the polarizer commonly employed is obtained by dyeing a stretched polyvinyl alcohol (PVA)-based film with iodine or a dichroic dye and as the protective film, a cellulose ester film or the like is used.

Resulting from quality improvement of the recent liquid crystal display device, the usage is diversified and the demand for durability becomes strong. For example, stability against an environmental change is required in use for an outdoor application, and it is required also of an optical film used for the liquid crystal display device, such as the above-described polarizing plate protective film or optically compensatory film, to suppress a change in the dimension or optical properties due to a temperature or humidity change.

JP-A-2008-256747 (the term “JP-A” as used herein means an “unexamined published Japanese patent application”) discloses that deterioration in quality of a display image attributable to a change in the environment of a liquid crystal display device can be prevented by adopting a low moisture-permeable film as a surface film of a polarizing plate.

JP-A-2006-083225 describes a low moisture-permeable film having a cured layer obtained by coating a transparent substrate film with a curable composition containing a compound having a specific cyclic aliphatic hydrocarbon group and having two unsaturated double bond groups in the molecule, and curing the composition.

### SUMMARY OF THE INVENTION

Also, as regards a display device of a middle/small type employed in a tablet PC, mobile usage, etc. which are rapidly spreading in recent years, the demand for thickness reduction/space saving within a liquid crystal display device is high, and it is strongly required to solve the problem of light leakage over time in a high-temperature high-humidity environment. The cause of bringing about warpage of the liquid crystal cell or light leakage of a liquid crystal display device is considered as follows: a polarizing plate and an optical film constituting the polarizing plate, particularly a polarizer, absorb and release moisture to produce a shrinkage difference between polarizing plates on the front and rear surfaces of the liquid crystal cell of a liquid crystal display device and lose the balance, as a result, the liquid crystal cell is warped and four corners or four sides of the liquid crystal cell are put into contact with the casing or a member on the rear surface side to generate light leakage. Therefore, improvement of temperature dependency and wet heat durability is required of the protective film of a polarizing plate, but for drastic improvement, absorption and release of moisture due to an environmental change need to be suppressed, and more reduction of moisture permeability is required, among others, of an optical film on the outermost surface of a polarizing plate.

Under these circumstances, an object of the present invention, that is, the problem to be solved by the present invention, is to provide a polarizing plate protective film having low moisture permeability, and a production method thereof.

Another object of the present invention is to provide a polarizing plate using the polarizing plate protective film, and a liquid crystal display device using the polarizing plate and being excellent in the image quality after aging in a high-temperature high-humidity environment.

As a result of intensive studies, the present inventors have found that the moisture permeability can be reduced by using a low moisture-permeable film having, on a substrate film, a cured layer obtained from a curable composition containing, in a specific ratio, a monomer having a specific structure and a compound having a specific structure. Furthermore, it has been found that by using this optical film as a polarizing plate protective film, a liquid crystal display device improved in the light leakage after aging in a high-temperature high-humidity environment can be provided. The present invention has been accomplished based on these findings.

The problem to be solved by the present invention can be overcome by the present invention, that is, the following means.

[1] A polarizing plate protective film having, on a substrate film, a layer formed by curing a curable composition containing, setting a total solid content of the curable composition is 100 mass % (also referred to as “assuming that a total solid content of the curable composition is 100 mass %”), from 50 to 99 mass % of the following (A) and from 1 to 30 mass % of the following (B) based on the total solid content:

(A) at least either a compound having a cyclic aliphatic hydrocarbon group and an ethylenically unsaturated double bond or a compound having a fluorene ring and an ethylenically unsaturated double bond; and

(B) a compound having, in the molecule, at least one of a benzene ring and a cyclohexane ring, and at least one of a hydroxyl group and a carboxy group,

wherein a total number of the at least one of a benzene ring and a cyclohexane ring is 2 to 4, and a total number of the at least one of a hydroxyl group and a carboxy group is 1 to 2.

[2] The polarizing plate protective film as described in [1],

wherein (B) is a compound represented by any one of the following formulae (B-1) to (B-4):

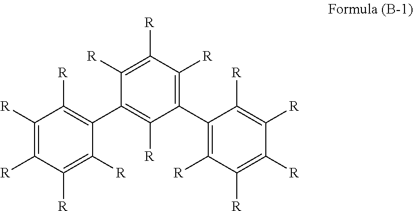

wherein in formula (B-1),

a total of 1 to 2 R out of a plurality of R represent at least either a hydroxy group or a carboxy group and each of other R independently represents a hydrogen atom or an alkyl group having a carbon number of 1 to 4;

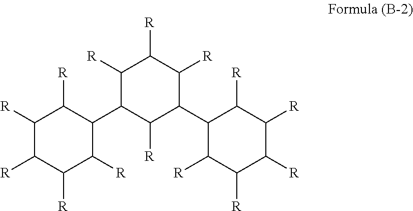

wherein in formula (B-2),

a total of 1 to 2 R out of a plurality of R represent at least either a hydroxy group or a carboxy group and each of other R independently represents a hydrogen atom or an alkyl group having a carbon number of 1 to 4;

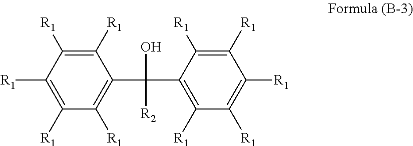

wherein in formula (B-3),

R₂ represents a hydrogen atom, an alkyl group having a carbon number of 1 to 4, or a group represented by the following formula (S1) or (S2); in formula (B-3) and the following formulae (S1) and (S2), each R₁ independently represents a hydrogen atom or an alkyl group having a carbon number of 1 to 4; and in the following formulae (S1) and (S2), * represents a bonding site to the carbon atom to which R₂ is bonded:

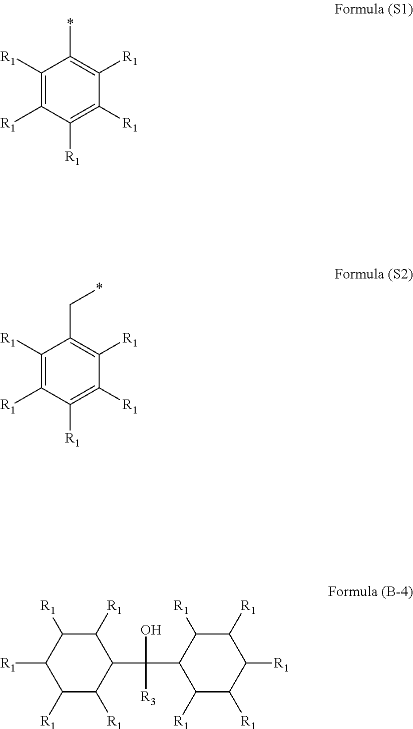

wherein in formula (B-4),

R₃ represents a hydrogen atom, an alkyl group having a carbon number of 1 to 4, or a group represented by the following formula (S3) or (S4); in formula (B-4) and the following formulae (S3) and (S4), each R₁ independently represents a hydrogen atom or an alkyl group having a carbon number of 1 to 4; and in the following formulae (S3) and (S4), * represents a bonding site to the carbon atom to which R₃ is bonded:

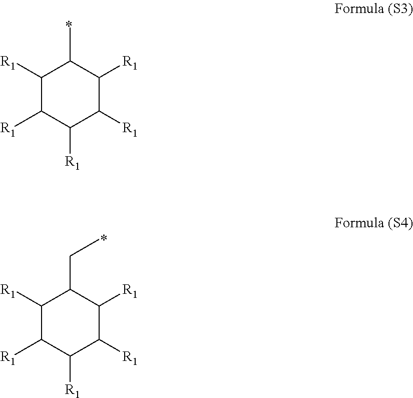

[3] The polarizing plate protective film as described in [1] or [2],

wherein the cyclic aliphatic hydrocarbon group in (A) is a group represented by the following formula (I):

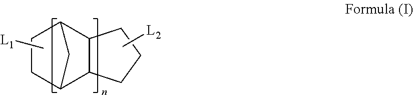

wherein in formula (I),

each of L₁ and L₂ independently represents a divalent or higher valent linking group, and n represents an integer of 1 to 3.

[4] The polarizing plate protective film as described in any one of [1] to [3],

wherein setting a total solid content of the curable composition to 100 mass %, the composition contains from 1 to 40 mass % of (C) a rosin compound based on the total solid content.

[5] The polarizing plate protective film as described in [4], wherein the rosin compound is one or more rosin compounds selected from rosin, a hydrogenated rosin, an acid-modified rosin and an esterified rosin.
[6] The polarizing plate protective film as described in any one of [1] to [5], wherein the substrate film is a cellulose acylate film.
[7] The polarizing plate protective film as described in any one of [1] to [6], further having a hardcoat layer on the layer formed by curing a curable composition containing (A) and (B).
[8] A method for producing a polarizing plate protective film, comprising:

a step of forming, on a substrate film, a layer by curing a curable composition containing, setting a total solid content of the curable composition to 100 mass %, from 50 to 99 mass % of the following (A) and from 1 to 30 mass % of the following (B) based on the total solid content:

(A) at least either a compound having a cyclic aliphatic hydrocarbon group and an ethylenically unsaturated double bond or a compound having a fluorene ring and an ethylenically unsaturated double bond; and

(B) a compound having, in the molecule, at least one of a benzene ring and a cyclohexane ring, and at least one of a hydroxyl group and a carboxy group, wherein a total number of the at least one of a benzene ring and a cyclohexane ring is 2 to 4, and a total number of the at least one of a hydroxyl group and a carboxy group is 1 to 2.

[9] A polarizing plate comprising a polarizer and, as a protective film of the polarizer, at least one polarizing plate protective film described in [7].
[10] A liquid crystal display device comprising:

a liquid crystal cell and

the polarizing plate described in [9] disposed on at least one surface of the liquid crystal phase,

wherein the polarizing plate protective film is disposed on the outermost surface.

According to the present invention, a polarizing plate protective film having low moisture permeability can be provided. Also, a polarizing plate using a polarizer and the polarizing plate protective film, and a liquid crystal display device using the polarizing plate can be provided, whereby a liquid crystal display device reduced in the generation of light leakage after aging in a high-temperature high-humidity environment can be provided.

### DETAILED DESCRIPTION OF THE INVENTION

The polarizing plate protective film of the present invention, a production method thereof, additives used therein, and the like are described in detail below.

In the following, the constitutional requirements are described based on representative embodiments of the present invention, but the present invention is not limited to these embodiments. Incidentally, in the description of the present invention, the numerical range expressed using “to” denotes a range including numerical values before and after “to” as a lower limit value and an upper limit value, respectively.

The solid content indicates components excluding solvents in the curable composition.

The “acrylic resin” means a resin obtained by polymerizing a derivative of methacrylic acid or acrylic acid, or a resin containing the derivative. Also, unless limited otherwise, the “(meth)acrylate” indicates at least either acrylate or methacrylate, and the “(meth)acryl” indicates at least either acryl or methacryl.

Furthermore, the “slow axis direction” of the film means a direction where the refractive index becomes maximum in the film plane, and the “fast axis direction” means a direction orthogonal to the slow axis in the film plane.

### [Polarizing Plate Protective Film and Production Method of Polarizing Plate Protective Film]

The polarizing plate protective film of the present invention has, on a substrate film, a layer (hereinafter, sometimes simply referred to as “low moisture-permeable layer”) formed by curing a curable composition containing, assuming that a total solid content of the curable composition is 100 mass %, from 50 to 99 mass % of the following (A) and from 1 to 30 mass % of the following (B) based on the total solid content:

(A) at least either a compound having a cyclic aliphatic hydrocarbon group and an ethylenically unsaturated double bond or a compound having a fluorene ring and an ethylenically unsaturated double bond; and

(B) a compound having, in the molecule, at least one of a benzene ring and a cyclohexane ring, and at least one of a hydroxyl group and a carboxy group, wherein a total number of the at least one of a benzene ring and a cyclohexane ring is 2 to 4, and a total number of the at least one of a hydroxyl group and a carboxy group is 1 to 2.

In the present invention, the low moisture-permeable layer indicates a layer formed by curing a curable composition containing, assuming that a total solid content of the curable composition is 100 mass %, from 50 to 99 mass % of (A) and from 1 to 30 mass % of (B) based on the total solid content. (In this specification, mass ratio is equal to weight ratio.)

The moisture permeability of the low moisture-permeable layer is, as a moisture permeability per a film thickness of 10 μm, preferably from 5.0 to 250 g/m²/day, more preferably from 5.0 to 100 g/m²/day, still more preferably from 5.0 to 65 g/m²/day.

Also, the production method of a polarizing plate protective film of the present invention includes a step of forming, on a substrate film, a low moisture-permeable layer by curing a curable composition containing, assuming that a total solid content of the curable composition is 100 mass %, from 50 to 99 mass % of (A) and from 1 to 30 mass % of (B) based on the total solid content.

### (Moisture Permeability of Polarizing Plate Protective Film)

The polarizing plate protective film of the present invention contains (A) and (B) with the contents above in the low moisture-permeable layer, and the moisture permeability reduction can be achieved by the synergistic effect of (A) and (B), whereby the film can have excellent durability and be reduced in the moisture permeability.

The polarizing plate protective film of the present invention preferably has a moisture permeability of 5.0 to 100 g/m²/day.

(Here, the moisture permeability is a value after the passing of 24 hours at 40° C. and a relative humidity of 90% according to JIS Z-0208.)

The moisture permeability of the polarizing plate protective film of the present invention is preferably 90 g/m²/day or less, more preferably 80 g/m²/day or less, still more preferably 70 g/m²/day or less, yet still more preferably 60 g/m²/day or less. When the moisture permeability is 100 g/m²/day or less, the liquid crystal display device can be prevented from light leakage accompanying warpage of the liquid crystal cell after aging in an ordinary temperature environment, in a high-humidity environment or in a high-temperature high-humidity environment.

### {Low Moisture-Permeable Layer}

The low moisture-permeable layer in the polarizing plate protective film of the present invention is a layer formed by curing a curable composition containing from 50 to 99 mass % of (A) and from 1 to 30 mass % of (B) based on the total solid content. A curable composition further containing, if desired, a rosin compound, a polymerization initiator, a light-transmitting particle, a fluorine- or silicon-containing compound, and a solvent is coated, dried and cured on a substrate film directly or through another layer, whereby the low moisture-permeable layer can be formed. Respective components are described below.

### [(A) at Least Either a Compound Having a Cyclic Aliphatic Hydrocarbon Group and an Ethylenically Unsaturated Double Bond or a Compound Having a Fluorene Ring and an Ethylenically Unsaturated Double Bond]

Hereinafter, (A) above is sometimes referred to as the component (A).

The component (A) may contain only a compound having a cyclic aliphatic hydrocarbon group and an ethylenically unsaturated double bond, may contain only a compound having a fluorene ring and an ethylenically unsaturated double bond, or may contain both a compound having a cyclic aliphatic hydrocarbon group and an ethylenically unsaturated double bond and a compound having a fluorene ring and an ethylenically unsaturated double bond.

### [Compound Having a Cyclic Aliphatic Hydrocarbon Group and an Ethylenically Unsaturated Double Bond]

The compound having a cyclic aliphatic hydrocarbon group and an ethylenically unsaturated double bond can function as a binder.

By virtue of using a compound having a cyclic aliphatic hydrocarbon group and an ethylenically unsaturated double bond, low moisture permeability can be realized, the adhesiveness of the substrate film or other layers to the low moisture-permeability can be excellent, and furthermore, light leakage of the polarizing plate can be prevented. Although details are not clearly known, it is considered that: by using a compound having a cyclic aliphatic hydrocarbon group in the molecule, a hydrophobic cyclic aliphatic hydrocarbon group is introduced into the low moisture-permeable layer to achieve hydrophobization, and this makes it possible to prevent taking in molecules from outside and reduce the moisture permeability; by having an ethylenically unsaturated double bond in the molecule, the crosslinking site density is increased, and the diffusion path of water molecules in the low moisture-permeable layer is limited; and the increase in the crosslinking site density also produces an effect of relatively increasing the density of the cyclic aliphatic hydrocarbon group, and the inside of the low moisture-permeable layer is thereby made more hydrophobic, as a result, adsorption of water molecules is prevented and the moisture permeability is reduced.

In order to increase the crosslinking site density, the number of ethylenically unsaturated double bonds contained in the molecule is preferably 2 or more.

In this case, a compound having a cyclic aliphatic hydrocarbon group, in which the number of ethylenically unsaturated double bonds is 2 or more, and a compound having a cyclic aliphatic hydrocarbon group, in which the number of ethylenically unsaturated double bonds is 1, may be mixed and used.

The cyclic aliphatic hydrocarbon group is preferably a group derived from an alicyclic compound having a carbon number of 7 or more, more preferably a group derived from an alicyclic compound having a carbon number of 10 or more, still more preferably a group derived from an alicyclic compound having a carbon number of 12 or more.

The cyclic aliphatic hydrocarbon group is, among others, preferably a group derived from a polycyclic compound such as bicyclic and tricyclic compounds.

For example, a central scaffold of the compound described in the claims of JP-A-2006-215096, a central scaffold of the compound described in JP-A-2001-10999, and a scaffold of an adamantane derivative are more preferred.

The cyclic aliphatic hydrocarbon group specifically includes a norbornane group, a tricyclodecane group, a tetracyclododecane group, a pentacyclopentadecane group, an adamantane group, a diamantane group, etc.

The cyclic aliphatic hydrocarbon group (including a linking group) is preferably a group represented by any one of the following formulae (I) to (V), more preferably a group represented by the following formula (I), (II) or (IV), still more preferably a group represented by the following formula (I) or (IV), yet still more preferably a group represented by the following formula (I):

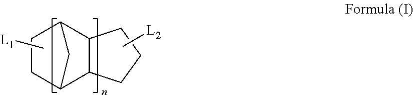

wherein in formula (I), each of L₁ and L₂ independently represents a single bond or a divalent or higher valent linking group, and n represents an integer of 1 to 3;

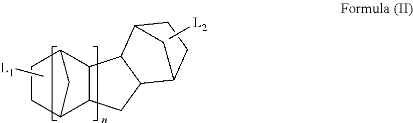

wherein in formula (II), each of L₁ and L₂ independently represents a single bond or a divalent or higher valent linking group, and n represents an integer of 1 to 2;

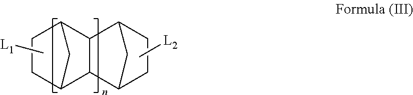

wherein in formula (III), each of L₁ and L₂ independently represents a single bond or a divalent or higher valent linking group, and n represents an integer of 1 to 2;

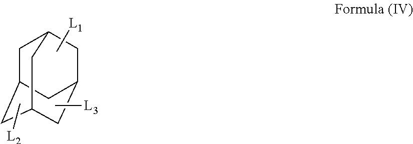

wherein in formula (IV), each of L₁ and L₂ independently represents a single bond or a divalent or higher valent linking group, and L₃ represents a hydrogen atom, a single bond or a divalent or higher valent linking group; and

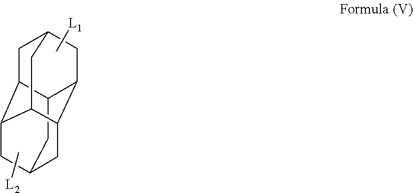

wherein in formula (V), each of L₁ and L₂ independently represents a single bond or a divalent or higher valent linking group.

The divalent or higher valent linking group of L₁, L₂ and L₃ includes an alkylene group having a carbon number of 1 to 6, which may be substituted at the N-position, an amide bond which may be substituted at the N-position, an ester bond, an oxycarbonyl group, an ether bond, and a group formed by combining two or more members thereof.

The ethylenically unsaturated double bond in the component (A) includes a polymerizable functional group such as (meth)acryloyl group, vinyl group, styryl group and allyl group, and among these, a (meth)acryloyl group and —C(O)OCH═CH₂ are preferred. More preferably, the above-described compound containing two or more (meth)acryloyl groups per molecule is used as the component (A).

The compound having a cyclic aliphatic hydrocarbon group and containing two or more ethylenically unsaturated double bonds in the molecule is constituted by bonding the cyclic aliphatic hydrocarbon group to an ethylenically unsaturated double bond-containing group through a linking group.

Such a compound can be easily synthesized, for example, by a one-step or two-step reaction of a polyol, such as diol or triol, having the cyclic aliphatic hydrocarbon group, with a carboxylic acid, a carboxylic acid derivative, an epoxy derivative, an isocyanate derivative, etc. of a compound having a (meth)acryloyl group, a vinyl group, a styryl group, an allyl group, etc.

Preferably, the compound above may be synthesized through the reaction with a polyol having the cyclic aliphatic hydrocarbon group by using a compound such as (meth)acrylic acid, (meth)acryloyl chloride, (meth)acrylic anhydride and glycidyl (meth)acrylate, or a compound described in WO2012/00316A (e.g., 1,1-bis(acryloxymethyl)ethyl isocyanate).

Specific preferred examples of the compound having a cyclic aliphatic hydrocarbon group and an ethylenically unsaturated double bond are illustrated below, but the present invention is not limited thereto.

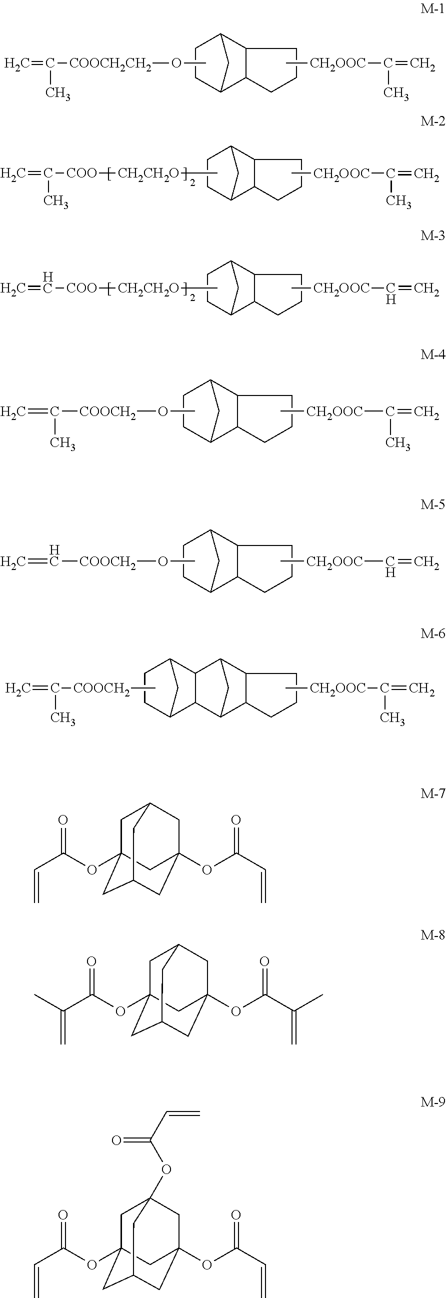

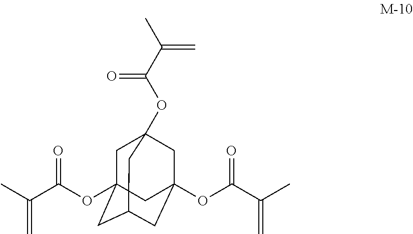 [SMILES: C=C(C)C(=O)OC12CC3CC(OC(=O)C(=C)C)(C1)CC(OC(=O)C(=C)C)(C3)C2]

### [Compound Having a Fluorene Ring and an Ethylenically Unsaturated Double Bond]

The compound having a fluorene ring and an ethylenically unsaturated double bond, which may be contained as the component (A) in the low moisture-permeable layer-forming curable composition, can function as a binder. In addition, the compound having a fluorene ring and an ethylenically unsaturated double bond can function as a curing agent, making it possible to enhance the strength or scratch resistance of the coating film and at the same time, impart low moisture permeability.

In order to increase the crosslinking site density, the number of ethylenically unsaturated double bonds in the molecule is preferably 2 or more.

The compound having a fluorene ring and an ethylenically unsaturated double bond is preferably represented by the following formula (VI):

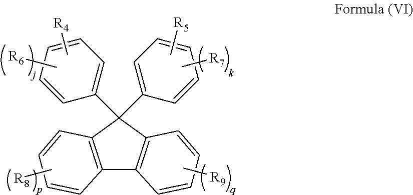

In formula (VI), each of R₄, R₅, R₆, R₇, R₈ and R₉ independently represents a monovalent substituent, each of j, k, p and q independently represents an integer of 0 to 4, and at least either R₄ or R₅ represents a monovalent organic group having an ethylenically unsaturated double bond.

A preferred embodiment of formula (VI) as the compound having a fluorene ring and an ethylenically unsaturated double bond in the molecule is represented by the following formula (VII):

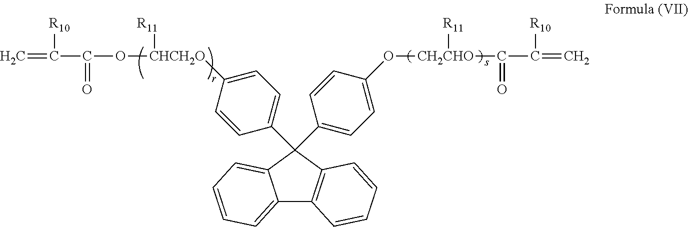

In formula (VII), each of R₁₀ and R₁₁ independently represents a hydrogen atom or a methyl group, and each of r and s independently represents an integer of 0 to 5.

The content of the component (A) is, assuming that a total solid content of the low moisture-permeable layer-forming curable composition is 100 mass %, from 50 to 99 mass % based on the solid content, and in view of pronounced reduction of moisture permeability by the synergistic effect of (A) and (B), the content is preferably from more than 50 mass % to 99 mass %, more preferably from 55 to 95 mass %, yet still more preferably from 60 to 90 mass %.

### [Compound Having Neither a Cyclic Aliphatic Hydrocarbon Group Nor a Fluorene Ring and Having an Ethylenically Unsaturated Double Bond]

In the low moisture-permeable layer-forming composition for use in the present invention, a compound having neither a cyclic aliphatic hydrocarbon group nor a fluorene ring and having an ethylenically unsaturated double bond can be used in combination as long as the effects of the present invention are not impaired.

The compound having no cyclic aliphatic hydrocarbon group and no fluorene ring and having an ethylenically unsaturated double bond is preferably a (meth)acrylate compound having no cyclic aliphatic hydrocarbon group and no fluorene ring, and examples thereof include (meth)acrylic acid diesters of an alkylene glycol, (meth)acrylic acid diesters of a polyoxyalkylene glycol, (meth)acrylic acid diesters of a polyhydric alcohol, (meth)acrylic acid diesters of an ethylene oxide or propylene oxide adduct, epoxy (meth)acrylates, urethane (meth)acrylates, and polyester (meth)acrylates.

Among others, esters of a polyhydric alcohol and a (meth)acrylic acid are preferred. Examples thereof include 1,4-butanediol di(meth)acrylate, 1,6-hexanediol di(meth)acrylate, neopentyl glycol (meth)acrylate, ethylene glycol di(meth)acrylate, triethylene glycol di(meth)acrylate, pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphoric acid tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dip entaerythritol hexa(meth)acrylate, polyurethane polyacrylate, polyester polyacrylate, and caprolactone-modified tris(acryloxyethyl)isocyanurate.

As the (meth)acryloyl group-containing polyfunctional acrylate-based compounds, a commercially available compound may be used, and examples thereof include NK Ester A-TMMT produced by Shin-Nakamura Chemical Co., Ltd., and KAYARAD DPHA produced by Nippon Kayaku Co., Ltd. The polyfunctional monomer is described in paragraphs [0114] to [0122] of JP-A-2009-98658, and those described therein may be used also in the present invention.

In view of adhesiveness to the support and low curl, the compound having no cyclic aliphatic hydrocarbon group and having an ethylenically unsaturated double bond is preferably a compound having a hydrogen-bonding substituent. The hydrogen-bonding substituent indicates a substituent in which an atom such as nitrogen, oxygen, sulfur and halogen is bonded to a hydrogen bond by covalent bonding, and specifically includes —OH, —SH, —NH—, —CHO, —CONH—, —OCONH—, etc., and urethane (meth)acrylates and hydroxyl group-containing (meth)acrylates are preferred. A commercially available polyfunctional acrylate having a (meth)acryloyl group may also be used, and examples thereof include NK Oligo U4HA and NK Ester A-TMM-3, both produced by Shin-Nakamura Chemical Co., Ltd., and KAYARAD PET-30 produced by Nippon Kayaku Co., Ltd.

In the case of containing a compound having no cyclic aliphatic hydrocarbon group and no fluorene ring and having an ethylenically unsaturated double bond, the content thereof is, assuming that a total solid content of the low moisture-permeable layer-forming curable composition is 100 mass %, preferably from 1 to 30 mass %, more preferably from 2 to 20 mass %, still more preferably from 3 to 15 mass %, based on the total solid content assumed to be 100 mass %.

[(B) Compound Having, in the Molecule, at Least One of a Benzene Ring and a Cyclohexane Ring, and at Least One of a Hydroxyl Group and a Carboxy Group, Wherein a Total Number of the at Least One of a Benzene Ring and a Cyclohexane Ring is 2 to 4, and a Total Number of the at Least One of a Hydroxyl Group and a Carboxy Group is 1 to 2.]

Hereinafter, (B) above is sometimes referred to as the compound (B) of the component (B).

The component (B) may contain only from 2 to 4 benzene rings, may contain only from 2 to 4 cyclohexane rings, or may contain a total of 2 to 4 benzene rings and cyclohexane rings (for example, containing one benzene ring and one cyclohexane ring). Also, the component (B) may contain only from 1 to 2 hydroxy groups, may contain only from 1 to 2 carboxy groups, or may contain a total of 1 to 2 hydroxy groups and carboxy groups (for example, containing one hydroxyl group and one carboxy group).

In the present invention, the low moisture-permeable layer-forming composition contains the compound (B).

The compound (B) has a role in more enhancing the water vapor barrier property per film thickness (reducing the moisture vapor transmission rate) than in the case of forming a cured film by using only the component (A) as the binder. As a result of intensive studies to enhance the water vapor barrier property by focusing on the free volume in the cured film, which is one of the causes for the inefficiency of barrier property, the present inventors have found out the compound (B) as an additive.

As to the free volume and gas permeation, it is disclosed, for example, in “Kobunshi Kotai no Jiyu Taiseki (Free Volume of Polymer Solid)” (see, Hideyuki Itagaki, Polymer, Vol. 43, June 1994, pp. 432-437) that as the oxygen permeation coefficient is lower, the free volume is smaller.

The present inventors have thought that main additive requirements necessary for efficiently decreasing the free volume in using the component (A) as the main binder are the following 4 points:

(1) the molecular size is relatively small while having a volume necessary to fill the free volume,

(2) the affinity for the component (A) in the film is high,

(3) the compound (B) is less likely to self-associate, and

(4) no volatilization/diffusion occurs during formation of a cured film.

First, since a water molecule cannot pass through the inside of a benzene ring or a cyclohexane ring, those groups are considered as a minimum unit, and the compound (B) having at least either one group can fill the free volume. The benzene ring or cyclohexane ring has high affinity for the cyclic aliphatic hydrocarbon group or fluorene ring of the component (A) and in turn, the affinity of the compound (B) for the component (A) is high.

The number of benzene rings and cyclohexane rings is from 2 to 4 in total per molecule and if the total of the rings above is 1 or less, the volatility is high, whereas if the total is 5 or more, the molecule becomes bulky and the effect of decreasing the free volume may be reduced or conversely, the free volume may be increased.

On the other hand, the compound (B) has a benzene ring or cyclohexane ring having no polarity and a hydroxy group or carboxy group having porality, so that self-association of the compound (B) can be prevented. At the same time, when the component (A) has a (meth)acryloyl group, the compound has affinity for the ester bond of the component (A), and this is considered to contribute to increasing the affinity for the component (A).

The benzene ring or cyclohexane ring may have a substituent, but when the substituent is large, the molecule becomes bulky and the effect of decreasing the free volume is reduced. Therefore, the substituent is preferably an alkyl group having a carbon number of 1 to 4.

Preferred examples of the compound (B) include a compound represented by any one of the following formulae (B-1) to (B-4):

### (Compound Represented by Formula (B-1))

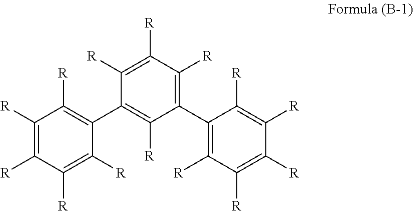

In formula (B-1), a total of 1 to 2 R out of a plurality of R represent at least either a hydroxy group or a carboxy group and each of other R independently represents a hydrogen atom or an alkyl group having a carbon number of 1 to 4.

Out of a plurality of R, a total of 1 to 2 R are preferably a hydroxy group, and other R are preferably any one of a hydrogen atom, a methyl group and an ethyl group, more preferably a hydrogen atom or a methyl group, still more preferably a hydrogen atom.

### (Compound Represented by Formula (B-2))

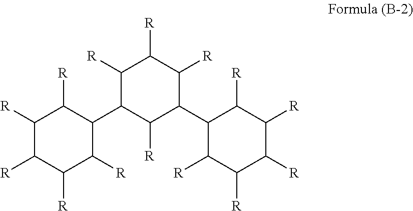

In formula (B-2), a total of 1 to 2 R out of a plurality of R represent at least either a hydroxy group or a carboxy group and each of other R independently represents a hydrogen atom or an alkyl group having a carbon number of 1 to 4.

R in formula (B-2) has the same meaning as R in (B−1), and the preferred range of R is also the same as in formula (B-1).

### (Compound Represented by Formula (B-3))

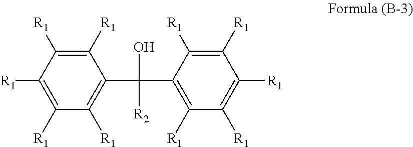

In formula (B-3), R₂ represents a hydrogen atom, an alkyl group having a carbon number of 1 to 4, or a group represented by the following formula (S1) or (S2); in formula (B-3) and the following formulae (S1) and (S2), each R₁ independently represents a hydrogen atom or an alkyl group having a carbon number of 1 to 4; and in the following formulae (S1) and (S2), * represents a bonding site to the carbon atom to which R₂ is bonded:

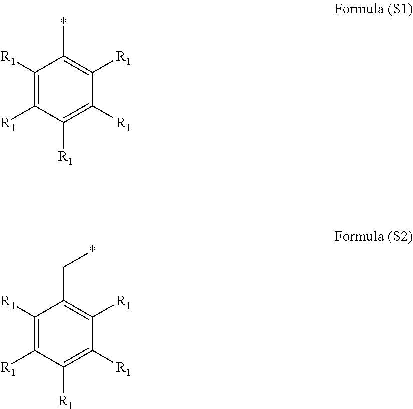

In formula (B-3), R₁ is preferably a hydrogen atom, a methyl group or an ethyl group, more preferably a hydrogen atom or a methyl group, still more preferably a hydrogen atom. R₂ is preferably a group represented by formula (S1) or (S2), more preferably a group represented by formula (S1).

R₁ in formulae (S1) and (S2) has the same meaning as R₁ in formula (B-3), and the preferred range is also the same.

### (Compound Represented by Formula (B-4))

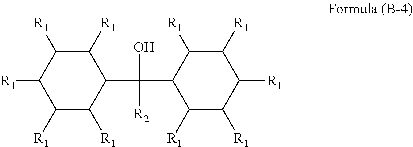

In formula (B-4), R₃ represents a hydrogen atom, an alkyl group having a carbon number of 1 to 4, or a group represented by the following formula (S3) or (S4); in formula (B-4) and the following formulae (S3) and (S4), each R₁ independently represents a hydrogen atom or an alkyl group having a carbon number of 1 to 4; and in the following formulae (S3) and (S4), * represents a bonding site to the carbon atom to which R₃ is bonded:

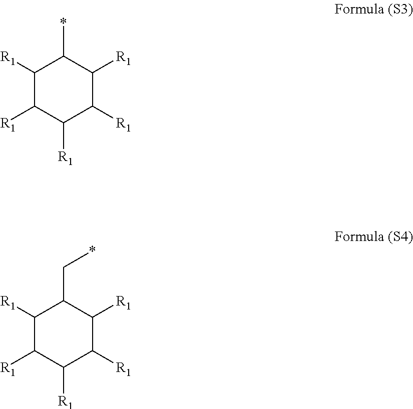

In formula (B-4), R₁ is preferably a hydrogen atom, a methyl group or an ethyl group, more preferably a hydrogen atom or a methyl group, still more preferably a hydrogen atom. R₂ is preferably a group represented by formula (S3) or (S4), more preferably a group represented by formula (S3).

R₁ in formulae (S3) and (S4) has the same meaning as R₁ in formula (B-4), and the preferred range is also the same.

Among formulae (B-1) to (B-4), a compound represented by formula (B-2) or (B-4) having a cyclohexyl ring is preferred.

Preferred examples of the compound represented by formulae (B-1) to (B-4) for use in the present invention are illustrated below, but the present invention is not limited to these specific examples.

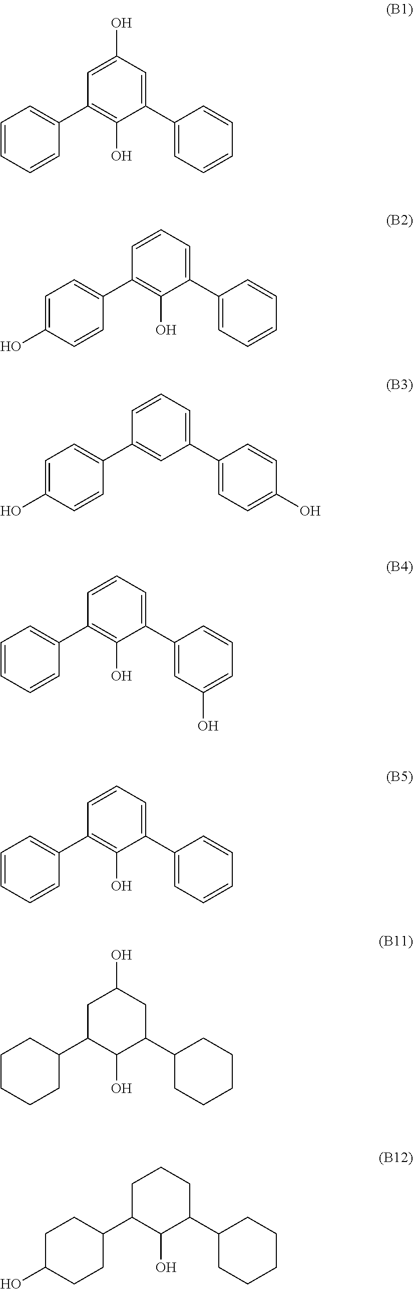

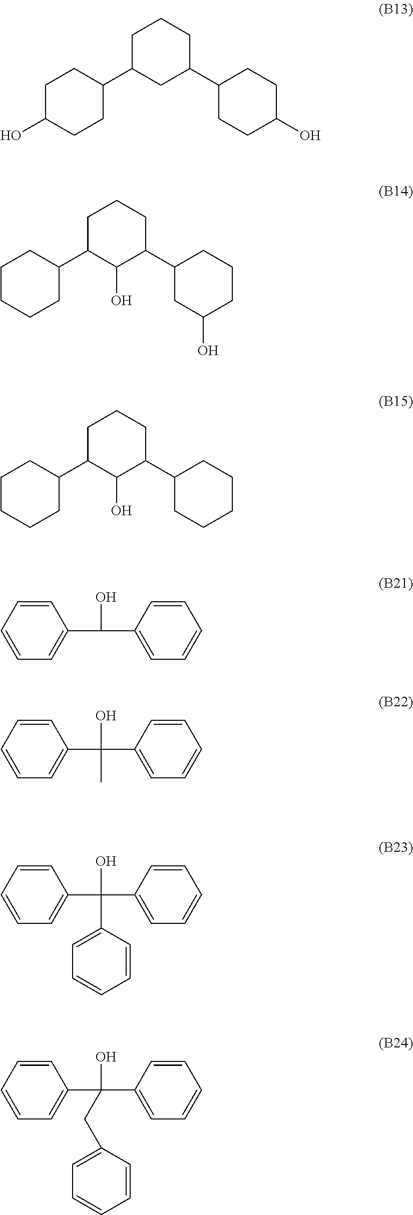

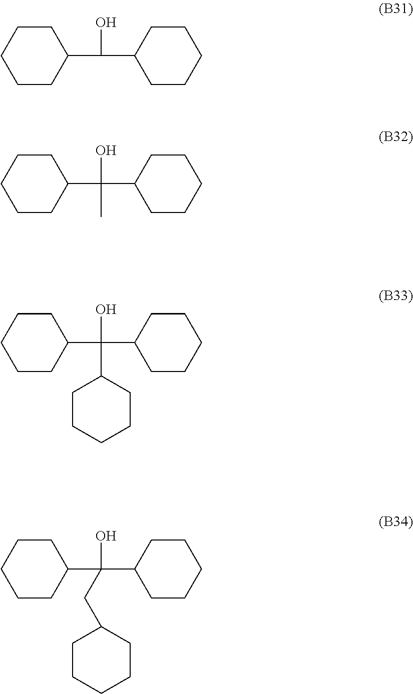 [SMILES: OC(C1CCCCC1)C1CCCCC1 ; CC(O)(C1CCCCC1)C1CCCCC1 ; OC(C1CCCCC1)(C1CCCCC1)C1CCCCC1 ; OC(CC1CCCCC1)(C1CCCCC1)C1CCCCC1]

The content of the compound (B) is, assuming that a total content of the low moisture-permeable layer-forming curable composition is 100 mass %, from 1 to 30 mass %, preferably from 3 to 25 mass %, more preferably from 5 to 20 mass %.

The compound represented by any one of formulae (B-1) to (B-4) can be synthesized by a known method. Also, a commercially available product may be used.

As regards the synthesis method, for example, out of the compounds represented by formula (B-1), 2,6-diphenylphenol of (B5) and a derivative thereof, which may be preferably used in the present invention, can be synthesized by the method described in JP-A-2009-269868.

The compound represented by formula (B-2) can be synthesized by hydrogenating the compound represented by formula (B-1). For example, out of the compounds represented by formula (B-2), the compound of (B15) and a derivative thereof can be synthesized by replacing the dehydrogenation reaction in the second step of the reaction formula (7) in paragraph [0020] of JP-A-2009-269868 by a hydrogenation reaction.

The compounds represented by formulae (B-3) and (B-4) can be synthesized by a Grignard reaction. The compound represented by formula (B-4) can also be synthesized by hydrogenating the compound represented by formula (B-3).

### [(C) Rosin Compound]

In the present invention, it is also preferable to incorporate a rosin compound into the low moisture-permeable layer-forming curable composition. By incorporating a rosin compound, the moisture permeability can be more reduced.

The rosin compound is preferably one or more members selected from rosin, a hydrogenated rosin (sometimes referred to as rosin hydride), an acid-modified rosin and an esterified rosin (sometimes referred to as rosin ester).

The rosin includes an unmodified rosin such as tall oil rosin, gum rosin and wood rosin, containing, as the main component, a resin acid such as abietic acid, levopimaric acid, palustric acid, neoabietic acid, dehydroabietic acid or dihydroabietic acid.

The hydrogenated rosin indicates a rosin obtained by hydrogenating the rosin above and includes, for example, those containing a tetrahydro form such as tetrahydroabietic acid with a high content (for example, 50 mass % or more). The acid-modified rosin includes an unsaturated acid-modified rosin in which an unsaturated acid such as maleic acid, fumaric acid and acrylic acid is added by a Diels-Alder addition reaction, and more specifically, the acid-modified rosin includes, for example, a maleopimaric acid in which maleic acid is added to rosin, a fumaropimaric acid in which fumaric acid is added, and an acrylopimaric acid in which an acrylic acid is added. The esterified rosin includes, for example, an alkyl ester of rosin, a glycerin ester obtained by an esterification reaction of rosin and glycerin, and a pentaerythritol ester obtained by esterifying rosin and pentaerythritol.

The rosin ester above includes Super Ester E-720, Super Ester E-730-55, Super Ester E-650, Super Ester E-786-60, TAMANOL E-100, Emulsion AM-1002 and Emulsion SE-50 (all, trade names, special rosin ester emulsions, produced by Arakawa Chemical Industries, Ltd.); Super Ester L, Super Ester A-18, Super Ester A-75, Super Ester A-100, Super Ester A-115, Super Ester A-125 and Super Ester T-125 (all, trade names, special rosin esters, produced by Arakawa Chemical Industries, Ltd.); etc.

In addition, the rosin ester includes ESTER GUM AAG, ESTER GUM AAL, ESTER GUM A, ESTER GUM AAV, ESTER GUM 105, ESTER GUM HS, ESTER GUM AT, ESTER GUM H, ESTER GUM HP, ESTER GUM HD, PENSEL A, PENSEL AD, PENSEL AZ, PENSEL C, PENSEL D-125, PENSEL D-135, PENSEL D-160 and PENSEL KK (all, trade names, rosin ester-based resins, produced by Arakawa Chemical Industries, Ltd.).

Other rosins include RONDIS R, RONDIS K-25, RONDIS K-80 and RONDIS K-18 (all, trade names, rosin derivatives, produced by Arakawa Chemical Industries, Ltd.); PINECRYSTAL KR-85, PINECRYSTAL KR-120, PINECRYSTAL KR-612, PINECRYSTAL KR-614, PINECRYSTAL KE-100, PINECRYSTAL KE-311, PINECRYSTAL KE-359, PINECRYSTAL KE-604, PINECRYSTAL 30PX, PINECRYSTAL D-6011, PINECRYSTAL D-6154, PINECRYSTAL D-6240, PINECRYSTAL KM-1500 and PINECRYSTAL KM-1550 (all, trade names, ultra-light color-based rosin derivatives, produced by Arakawa Chemical Industries, Ltd.); ARADIME R-140 and ARADIME R-95 (both, trade names, polymerized rosins, produced by Arakawa Chemical Industries, Ltd.); HYPALE CH (all, trade name, hydrogenated rosin, produced by Arakawa Chemical Industries, Ltd.); BEAMSET 101 (all, trade name, rosin acrylate, produced by Arakawa Chemical Industries, Ltd.); etc.

In the present invention, the rosin compound is preferably subjected to acid modification and then to a hydrogenation treatment and thereafter used. By applying a hydrogenation treatment, the remaining double bond of the rosin compound can be prevented from being oxidized in a low moisture-permeable layer to cause coloring of the film.

The softening point of the rosin compound is preferably from 70 to 170° C. When the softening point of the rosin compound is 70° C. or more, the cured layer is not softened and exerts an excellent blocking property. When the softening point is less than 170° C., the solubility for a solvent can be maintained, and this is advantageous in that the haze of the cured layer is less likely to increase. The softening point of the rosin compound can be measured by the ring-and-ball method of JIS K-2531.

Also, from the standpoint of achieving both moisture permeability reduction and brittleness improving effect, the acid value of the rosin compound is preferably from 150 to 400 mgKOH/g, more preferably from 200 to 400 mgKOH/g, still more preferably from 280 to 400 mgKOH/g, yet still more preferably from 320 to 400 mgKOH/g. The acid value of the rosin compound can be measured according to the method described in JIS K5601-2-1.

In view of pronounced reduction of moisture permeability, the content of the rosin compound (C) is, assuming that a total solid content of the low moisture-permeable layer-forming curable composition is 100 mass %, preferably from 1 to 40 mass %, more preferably from 5 to 30 mass %, still more preferably from 10 to 25 mass %.

### [Inorganic Layered Compound]

In order to more reduce the moisture permeability of the low moisture-permeable layer of the present invention, it is also preferable to disperse an inorganic layered compound in the above-described binder usable for a low moisture-permeable layer. The inorganic layered compound has a hydrophilic surface and is preferably subjected to an organification treatment.

The inorganic layered compound is an inorganic compound having a structure where unit crystal layers are laminated, and exhibiting a property of undergoing swelling or cleavage by coordinating or absorbing a solvent between layers. Examples of such an inorganic compound include a swelling hydrous silicate, for example, a smectite group clay mineral (e.g., montmorillonite, saponite, hectorite), a vermiculite group clay mineral, a kaolinite group clay mineral, and a phyllosilicate (e.g., mica). A synthetic inorganic layered compound is also preferably used, and the synthetic inorganic layered compound includes a synthetic smectite (e.g., hectorite, saponite, stevensite), a synthetic mica, etc. Among these, smectite, montmorillonite and mica are preferred, and montmorillonite and mica are more preferred. The commercially available product that can be as the inorganic layered compound includes MEB-3 (aqueous dispersion liquid of synthetic mica, produced by CO-OP Chemical Co., Ltd.), ME-100 (synthetic mica, produced by CO-OP Chemical Co., Ltd.), S1ME (synthetic mica, produced by CO-OP Chemical Co., Ltd.), SWN (synthetic smectite, produced by CO-OP Chemical Co., Ltd.), SWF (synthetic smectite, produced by CO-OP Chemical Co., Ltd.), Kunipia F (purified bentonite, produced by Kunimine Industries Co., Ltd.), Bengel (purified bentonite, produced by Hojun Co., Ltd.), Bengel HV (purified bentonite, produced by Hojun Co., Ltd.), Bengel FW (purified bentonite, produced by Hojun Co., Ltd.), Bengel Bright 11 (purified bentonite, produced by Hojun Co., Ltd.), Bengel Bright 23 (purified bentonite, produced by Hojun Co., Ltd.), Bengel Bright 25 (purified bentonite, produced by Hojun Co., Ltd.), Bengel A (purified bentonite, produced by Hojun Co., Ltd.), Bengel 2M (purified bentonite, produced by Hojun Co., Ltd.), etc.

The inorganic layered compound is preferably a compound obtained by applying an organification treatment to such an inorganic layered compound.

The inorganic layered compound subjected to an organification treatment includes the organified inorganic layered compounds described in paragraphs 0038 to 0044 of JP-A-2012-234094.

From the standpoint of satisfying both the low moisture permeability and the adhesiveness between substrate film and low moisture-permeable layer, the swelling layered inorganic compound is preferably subjected to a microparticulation treatment. The microparticulated swelling layered inorganic compound usually has a plate-like or flat shape, and its planar shape is not particularly limited and may be an amorphous shape or the like. The average particle diameter (average particle diameter of the planar shape) of the microparticulated swelling layered inorganic compound is, for example, preferably from 0.1 to 10 μm, more preferably from 0.1 to 8 μm, still more preferably from 0.1 to 6 μm.

### [Polymerization Initiator]

The component (A) containing at least either a compound having a cyclic aliphatic hydrocarbon group and an ethylenically unsaturated double bond in the molecule or a compound having a fluorene ring and an ethylenically unsaturated double bond in the molecule preferably contains a polymerization initiator. The polymerization initiator is preferably a photopolymerization initiator.

The photopolymerization initiator includes acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, onium salts, borate salts, active esters, active halogens, inorganic complexes, coumarins, etc. Specific examples, preferred aspects, commercially available products and the like of the photopolymerization initiator are described in paragraphs [0151] of JP-A-2009-098658, and these may be suitably used likewise in the present invention.

Various examples of the photopolymerization initiator are described also in “Saishin UV Koka Gijutsu (Latest UV Curing Technology)” {Technical Information Institute Co., Ltd.} (1991), p. 159 and “Shigaisen Koka System (Ultraviolet Ray Curing System)” written by Kiyomi Kato (1989, published by United Engineering Center), pp. 65-148, and these are useful for the present invention.

Preferred examples of the commercially available photoradical polymerization initiator of photocleavage type include “Irgacure 651”, “Irgacure 184”, “Irgacure 819”, “Irgacure 907”, “Irgacure 1870” (a mixed initiator of CGI-403/Irgacure 184=7/3), “Irgacure 500”, “Irgacure 369”, “Irgacure 1173”, “Irgacure 2959”, “Irgacure 4265”, “Irgacure 4263”, “Irgacure 127”, “OXE01”, etc., produced by BASF (former Ciba Specialty Chemicals Inc.); “Kayacure DETX-S”, “Kayacure BP-100”, “Kayacure BDMK”, “Kayacure CTX”, “Kayacure BMS”, “Kayacure 2-EAQ”, “Kayacure ABQ”, “Kayacure CPTX”, “Kayacure EPD”, “Kayacure ITX”, “Kayacure QTX”, “Kayacure BTC”, “Kayacure MCA”, etc., produced by Nippon Kayaku Co., Ltd.; “Esacure (KIP100F, KB1, EB3, BP, X33, KT046, KT37, KIP150, and TZT)”, etc., produced by Sartomer Company Inc.; and a combination thereof.

The content of the photopolymerization initiator in the component (A) composition containing a compound having a cyclic aliphatic hydrocarbon group and an ethylenically unsaturated double bond in the molecule and a compound having a fluorene ring and an ethylenically unsaturated double bond in the molecule, which is used in the present invention, is preferably from 0.5 to 8 mass %, more preferably from 1 to 5 mass %, based on the total solid content in the composition, for the reason that the content is set to polymerize a polymerizable compound contained in the composition and prevent an excessive increase of the initiation site.

### [Ultraviolet Absorber]

The polarizing plate protective film of the present invention containing a low moisture-permeable layer can be used for a polarizing plate or a liquid crystal display device member, but from the standpoint of preventing deterioration of a polarizing plate, a liquid crystal cell, etc., the polarizing plate protective film may also be imparted with ultraviolet absorptivity by incorporating an ultraviolet absorber into the low moisture-permeable layer.

As the ultraviolet absorber, a known ultraviolet absorber may be used, and examples thereof include ultraviolet absorbers described in JP-A-2001-72782 and JP-T-2002-543265 (the term “JP-T” as used herein means a published Japanese translation of a PCT patent application). Specific examples and preferred examples of the ultraviolet absorber are the same as specific examples and preferred examples of the ultraviolet absorber described later in {Substrate Film} <Ultraviolet Absorber>.

### [Solvent]

The low moisture-permeable layer-forming curable composition may contain a solvent. As the solvent, various solvents may be used by taking into account the solubility of monomer, the drying property during coating, the dispersibility of light-transmitting particle, and the like. Such an organic solvent includes, for example, dibutyl ether, dimethoxyethane, diethoxyethane, propylene oxide, 1,4-dioxane, 1,3-dioxolane, 1,3,5-trioxane, tetrahydrofuran, anisole, phenetole, dimethyl carbonate, methyl ethyl carbonate, diethyl carbonate, acetone, methyl ethyl ketone (MEK), diethyl ketone, dipropyl ketone, diisobutyl ketone, cyclopentanone, cyclohexanone, methylcyclohexanone, ethyl formate, propyl formate, pentyl formate, methyl acetate, ethyl acetate, propyl acetate, methyl propionate, ethyl propionate, γ-butyrolactone, methyl 2-methoxyacetate, methyl 2-ethoxyacetate, ethyl 2-ethoxyacetate, ethyl 2-ethoxypropionate, 2-methoxyethanol, 2-propoxyethanol, 2-butoxyethanol, 1,2-diacetoxyacetone, acetylacetone, diacetone alcohol, methyl acetoacetate, ethyl acetoacetate, methyl alcohol, ethyl alcohol, isopropyl alcohol, n-butyl alcohol, cyclohexyl alcohol, isobutyl acetate, methyl isobutyl ketone (MIBK), 2-octanone, 2-heptanone, 2-hexanone, ethylene glycol ethyl ether, ethylene glycol isopropyl ether, ethylene glycol butyl ether, propylene glycol methyl ether, ethyl carbitol, butyl carbitol, hexane, heptane, octane, cyclohexane, methylcyclohexane, ethylcyclohexane, benzene, toluene, and xylene. One of these solvents may be used alone, or two or more thereof may be used in combination.

Among the solvents above, it is preferable to use at least one kind of a solvent out of methyl acetate, ethyl acetate, methyl ethyl ketone, acetylacetone, acetone, toluene and xylene.

The solvent is preferably used such that the solid content concentration of the low moisture-permeable layer-forming curable composition becomes from 20 to 80 mass %, more preferably from 30 to 75 mass %, still more preferably from 40 to 70 mass %.

### (Configuration and Production Method of Low Moisture-Permeable Layer)

The low moisture-permeable layer of the present invention may be one layer, or a plurality of layers may be provided. The method for stacking the low moisture-permeable layer is not particularly limited, but preferably, the low moisture-permeable layer is produced by co-casting with a substrate film or the low moisture-permeable layer is provided on the substrate film by coating, and more preferably, the low moisture-permeable layer is provided on the substrate film by coating.

### (Film Thickness of Low Moisture-Permeable Layer)

The film thickness of the low moisture-permeable layer of the present invention is preferably from 0.5 to 25 μm, more preferably from 1 to 20 μm, still more preferably from 2 to 18 μm, yet still more preferably from 3 to 17 μm.

### (Moisture Permeability of Low Moisture-Permeable Layer)

According to the gas permeation method of a composite film (Tsutomu Nakagawa, Hoso-zairyo no Barrier-sei no Kagaku (Hoso-gaku Kiso Koza 5) (Science of Barrier Property of Packaging Material (SPSTJ Basic Course 5)), pp. 68-72, Society of Packaging Science & Technology, Japan), assuming that the moisture permeability of a polarizing plate protective film in a stationary state is J_{f}, the moisture permeability of the substrate film is Jₛ, and the moisture permeability of the low moisture-permeable layer when the polarizing plate protective film is separated into the substrate film and the low moisture-permeable layer is J_{b}, the following formula holds:

1/J_{f}=1/Jₛ+1/J_{b} Formula (1)

The moisture permeability J_{f} of the polarizing plate protective film and the moisture permeability Jₛ of the substrate film can be measured directly, and based on these measured values, the moisture permeability J_{b} of the low moisture-permeable layer can be determined by calculation.

In the present invention, the moisture permeability of the low moisture-permeable layer is preferably from 5.0 to 100 g/m²/day.

### (Moisture Permeability Per Unit Film Thickness of Low Moisture-Permeable Layer)

The moisture permeability is generally known to be inversely proportional to the film thickness. Accordingly, the moisture permeability that can be achieved by the low moisture-permeable layer in the above-described film thickness range is determined by the moisture permeability per unit film thickness, which is a characteristic value of the material, and as the value thereof is smaller, a lower moisture permeability can be achieved. On the other hand, the moisture permeability can be adjusted by adjusting the film thickness of the low moisture-permeable layer based on the relationship above, but if the moisture permeability per unit film thickness is too low, the moisture permeability of the polarizing plate protective film becomes difficult to control.

In consideration of these two things, the moisture permeability of the low moisture-permeable layer per film thickness of 10 μm is preferably from 5.0 to 150 g/m²/day, more preferably from 10 to 100 g/m²/day, still more preferably from 20 to 90 g/m²/day, yet still more preferably from 30 to 80 g/m²/day (the moisture permeability is a value after the passing of 24 hours at 40° C. and a relative humidity of 90% according to JIS Z-0208).

Incidentally, the moisture permeability of the low moisture-permeable layer per film thickness of 10 μm is estimated as follows from the moisture permeabilities of the substrate film and polarizing plate protective film and the film thickness of the low moisture-permeable layer.

The moisture permeability C_{b}(10 μm) of the low moisture-permeable layer relative to a film thickness of 10 μm can be represented by the following formula based on J_{b} calculated above:

C_{b}(10 μm)=J_{b}×d_{b}/10 [g/m²/day] Formula (2)

(wherein d_{b} [μm] is the film thickness of the low moisture-permeable layer and as described above, can be determined from the difference in the film thickness between before and after stacking of the low moisture-permeable layer).

It is also preferred that the low moisture-permeable layer of the polarizing plate protective film of the present invention is designed to have, in combination, a hardcoat layer function, an antireflection function, an antifouling function, etc.

### {Substrate Film}

### [Material of Substrate Film]

The substrate film uses a polymer as the main component (accounting for 50 mass % or more in the substrate film). The polymer forming the substrate film is preferably a polymer excellent in the optical performance transparency, mechanical strength, thermal stability, isotropy, etc. The transparence as used in the present invention indicates that the visible light transmittance is 60% or more, and the visible light transmittance is preferably 80% or more, more preferably 90% or more. The polymer includes, for example, a polycarbonate-based polymer, a polyester-based polymer such as polyethylene terephthalate and polyethylene naphthalate, a (meth)acrylic polymer such as polymethyl methacrylate, and a styrene-based polymer such as polystyrene and acrylonitrile-styrene copolymer (AS resin). Other examples include a polyolefin-based polymer such as polyethylene, polyolefin (e.g., polypropylene) and ethylene-propylene copolymer, a vinyl chloride-based polymer, an amide-based polymer such as nylon and aromatic polyamide, an imide-based polymer, a sulfone-based polymer, a polyethersulfone-based polymer, a polyether ether ketone-based polymer, a polyphenylene sulfide-based polymer, a vinylidene chloride-based polymer, a vinyl butyral-based polymer, an allylate-based polymer, a polyoxymethylene-based polymer, an epoxy-based polymer, and a polymer obtained by mixing the polymers above. In addition, the polymer film of the present invention may also be formed as a cured layer of an ultraviolet-curable or thermosetting resin such as acrylic, urethane-based, acrylic urethane-based, epoxy-based or silicone-based resin.

As the material forming the substrate film, a cellulose-based polymer (among others, preferably cellulose acylate) typified by triacetyl cellulose, which has been conventionally employed as a transparent protective film for a polarizing plate, may also be preferably used. Furthermore, an acrylic film of which introduction as a polarizing plate protective film has been recently proposed, may also be preferably used. In the following, as an example of the substrate film of the present invention, cellulose acylate and a (meth)acrylic polymer are mainly described in detail, but the technical matters thereof can be applied likewise to other polymer films.

### [Cellulose Acylate Substitution Degree]

The cellulose acylate of the present invention produced using cellulose as a raw material is described below. The cellulose acylate is obtained by acylating the hydroxyl group of cellulose, and as the substituent thereof, any acyl group ranging from an acetyl group in which the number of carbon atoms is 2, to that in which the number of carbon atoms is 22, may be used. In the cellulose acylate of the present invention, the substitution degree of the acyl group for the hydroxyl group of cellulose is not particularly limited, but the substitution degree may be obtained by calculation after measuring the bonding degree of acetic acid and/or a carboxylic acid having a carbon atom number of 3 to 22 for acylating the hydroxyl group of cellulose. As the measurement method, the measurement may be performed in accordance with D-817-91 of ASTM.

The substitution degree of the acyl group for the hydroxyl group of cellulose is not particularly limited but is preferably from 2.50 to 3.00, more preferably from 2.75 to 3.00, still more preferably from 2.85 to 3.00.

The acetic acid and/or carboxylic acid having a carbon atom number of 3 to 22 for acylating the hydroxyl group of cellulose may be an aliphatic carboxylic acid or an aromatic carboxylic acid and may be either a single kind or a mixture of two or more kinds. The cellulose ester acylated thereby includes, for example, an alkylcarbonyl ester of cellulose, an alkenylcarbonyl ester of cellulose, an aromatic carbonyl ester of cellulose, and an aromatic alkyl carbonyl ester of cellulose, each of which may have a further substituted group. Preferred acyl groups include an acetyl group, a propionyl group, an n-butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an iso-butanoyl group, a cyclohexanecarbonyl group, an oleoyl group, a benzoyl group, a naphthylcarbonyl group, a cinnamoyl group, etc. Among these, an acetyl group, a propionyl group, a n-butanoyl group, a dodecanoyl group, an octadecanoyl group, an iso-butanoyl group, an oleoyl group, a benzoyl group, a naphthylcarbonyl group, a cinnamoyl group, etc. are preferred, and an acetyl group, a propionyl group and an n-butanoyl group are more preferred.

### <Cellulose Acylate-Based Substrate Film>

### [Polymerization Degree of Cellulose Acylate]

The polymerization degree of the cellulose acylate that is preferably used in the present invention is, in terms of the viscosity average polymerization degree, from 180 to 700 and in the cellulose acetate, more preferably from 180 to 550, still more preferably from 180 to 400, yet still more preferably from 180 to 350.

The substrate film is also preferably a (meth)acrylic polymer, more preferably a (meth)acrylic polymer having, in the main chain, at least any one structure of a lactone ring structure, an anhydrous glutaric acid ring structure and a glutarimide ring structure.

Here, the (meth)acrylic polymer is a concept encompassing both a methacrylic polymer and an acrylic polymer. Furthermore, the (meth)acrylic polymer encompasses an acrylate/methacrylate derivative, particularly an acrylate ester/methacrylate ester (co)polymer.

### ((Meth)acrylic Polymer)

The (meth)acrylic polymer preferably contains, as a repeating structural unit, a repeating structural unit derived from a (meth)acrylic acid ester monomer.

The (meth)acrylic polymer may further contain, as a repeating structural unit, a repeating structural unit constructed by polymerizing at least one member selected from a hydroxyl group-containing monomer, an unsaturated carboxylic acid and a monomer represented by the following formula (201): Formula (201):

CH₂═C(X)R²⁰¹

(wherein R²⁰¹ represents a hydrogen atom or a methyl group, X represents a hydrogen atom, an alkyl group having a carbon number of 1 to 20, an aryl group, a —CN group, a —CO—R²⁰² group or a —O—CO—R²⁰³ group, and each of R²⁰² and R²⁰³ represents a hydrogen atom or an organic residue having a carbon number of 1 to 20).

The (meth)acrylic acid ester is not particularly limited but includes, for example, an acrylic acid ester such as methyl acrylate, ethyl acrylate, n-butyl acrylate, isobutyl acrylate, tert-butyl acrylate, cyclohexyl acrylate and benzyl acrylate; and a methacrylic acid ester such as methyl methacrylate, ethyl methacrylate, propyl methacrylate, n-butyl methacrylate, isobutyl methacrylate, tert-butyl methacrylate, cyclohexyl methacrylate and benzyl methacrylate, and only one of these esters may be used, or two or more thereof may be used in combination. Among these, methyl methacrylate is excellent in the heat resistance and transparency and is preferred.

In the case of using the (meth)acrylic acid ester, the content ratio thereof to the monomer components used in the polymerization process is, from the standpoint of sufficiently bringing out the effects of the present invention, preferably from 10 to 100 mass %, more preferably from 10 to 100 mass %, still more preferably from 40 to 100 mass %, yet still more preferably from 50 to 100 mass %.

The hydroxyl group-containing monomer includes a 2-(hydroxyalkyl)acrylic acid ester such as α-hydroxymethylstyrene, α-hydroxyethylstyrene and methyl 2-(hydroxyethyl)acrylate; a 2-(hydroxyalkyl)acrylic acid such as 2-(hydroxyethyl)acrylic acid; etc., and only one of these monomers may be used, or two or more thereof may be used in combination.

The content ratio of the hydroxyl group-containing monomer to the monomer components used in the polymerization process is, from the standpoint of sufficiently bringing out the effect of the present invention, preferably from 0 to 30 mass %, more preferably from 0 to 20 mass %, still more preferably from 0 to 15 mass %, yet still more preferably from 0 to 10 mass %.

The unsaturated carboxylic acid includes, for example, an acrylic acid, a methacrylic acid, an α-substituted acrylic acid, and an α-substituted methacrylic acid, and only one of these acids may be used, or two or more thereof may be used in combination. Among these, in view of sufficiently bringing out the effects of the present invention, an acrylic acid and a methacrylic acid are preferred.

The content ratio of the unsaturated carboxylic acid to the monomer components used in the polymerization step is, from the standpoint of sufficiently bringing out the effects of the present invention, preferably from 0 to 30 mass %, more preferably from 0 to 20 mass %, still more preferably from 0 to 15 mass %, yet still more preferably from 0 to 10 mass %.

The monomer represented by formula (201) includes, for example, styrene, vinyltoluene, α-methylstyrene, acrylonitrile, methyl vinyl ketone, ethylene, propylene, and vinyl acetate, and only one of these monomers may be used, or two or more thereof may be used in combination. Among these, in view of sufficiently bringing out the effects of the present invention, styrene and α-methylstyrene are preferred.

The content ratio of the monomer represented by formula (201) to the monomer components used in the polymerization step is, from the standpoint of sufficiently bringing out the effects of the present invention, preferably from 0 to 30 mass %, more preferably from 0 to 20 mass %, still more preferably from 0 to 15 mass %, yet still more preferably from 0 to 10 mass %.

### [(Meth)Acrylic Polymer Having a Ring Structure in the Main Chain]

Among the (meth)acrylic polymers, a polymer having a ring structure in the main chain is preferred. By introducing a ring structure into the main chain, the rigidity of the main chain can be increased, and the heat resistance can be improved.

In the present invention, among the (meth)acrylic polymers having a ring structure in the main chain, any one polymer of a polymer having a lactone ring structure in the main chain, a polymer having an anhydrous glutaric acid ring structure in the main chain, and a polymer having a glutarimide ring structure in the main chain is preferred. Above all, a polymer containing a lactone ring structure in the main chain is more preferred.

These polymers having a ring structure in the main chain are described in sequence.

### ((Meth)Acrylic Polymer Having a Lactone Ring Structure in the Main Chain)

The (meth)acrylic polymer having a lactone ring structure in the main chain (hereinafter, sometimes referred to as the lactone ring-containing polymer) is not particularly limited as long as it is a (meth)acrylic polymer having a lactone ring in the main chain, but the polymer preferably has a lactone ring structure represented by the following formula (401):

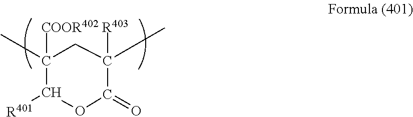

In formula (401), each of R⁴⁰¹, R⁴⁰² and R⁴⁰³ independently represents a hydrogen atom or an organic residue having a carbon atom number of 1 to 20, and the organic residue may contain an oxygen atom. Here, the organic residue having a carbon atom number of 1 to 20 is preferably a methyl group, an ethyl group, an isopropyl alcohol, an n-butyl group, a tert-butyl group, etc.

The content ratio of the lactone ring structure represented by formula (401) to the structures in the lactone ring-containing polymer is preferably from 5 to 90 mass %, more preferably from 10 to 70 mass %, still more preferably from 10 to 60 mass %, yet still more preferably from 10 to 50 mass %. When the content ratio of the lactone ring structure is 5 mass % or more, the heat resistance and surface hardness of the obtained polymer tends to be enhanced, and when the content ratio of the lactone ring structure is 90 mass % or less, the molding processability of the obtained polymer tend to be improved.

The production method of the lactone ring-containing polymer is not particularly limited, but the lactone ring-containing polymer is preferably produced by obtaining (p) a polymer having a hydroxyl group and an ester group in the molecular chain through a polymerization process, and then performing a lactone cyclization condensation process of heat-treating the obtained polymer (p) to thereby introduce a lactone ring structure into the polymer.

The mass average molecular weight of the lactone ring-containing polymer is preferably from 1,000 to 2,000,000, more preferably from 5,000 to 1,000,000, still more preferably from 10,000 to 500,000, yet still more preferably from 50,000 to 500,000.

The mass decrease ratio of the lactone ring-containing polymer in the range from 150° C. to 300° C. in the dynamic TG measurement is preferably 1% or less, more preferably 0.5% or less, still more preferably 0.3% or less. As for the dynamic TG measurement method, the method described in JP-A-2002-138106 may be used.

The lactone ring-containing polymer has a high cyclization condensation reaction rate and therefore, a dealcoholization reaction is less likely to occur in the production process of a molded article, so that a defect such as bubble or silver streak attributable to the alcohol above can be avoided from entering in the molded article after the molding. Furthermore, a lactone ring structure is sufficiently introduced into the polymer due to high cyclization condensation reaction rate and therefore, the obtained lactone ring-containing polymer has high heat resistance.

The coloring degree (YI) of the lactone ring-containing polymer when formed into a chloroform solution having a concentration of 15 mass % is preferably 6 or less, more preferably 3 or less, still more preferably 2 or less, yet still more preferably 1 or less. When the coloring degree (YI) is 6 or less, a problem such as damage of the transparency due to coloring is less likely occur and therefore, the polymer can be preferably used in the present invention.

The 5% mass decrease temperature of the lactone ring-containing polymer in the thermogravimetry (TG) is preferably 330° C. or more, more preferably 350° C. or more, still more preferably 360° C. or more. The 5% mass decrease temperature in the thermogravimetry (TG) is indicative of thermal stability and when this is 330° C. or more, sufficient thermal stability tends to be exerted. The thermogravimetry may be performed using the apparatus in the dynamic TG measurement above.

The glass transition temperature (Tg) of the lactone ring-containing polymer is preferably 115° C. or more, more preferably 125° C. or more, still more preferably 130° C. or more, yet still more preferably 135° C. or more, and most preferably 140° C. or more.

The total amount of residual volatile matters contained in the lactone ring-containing polymer is preferably 5,000 ppm or less, more preferably 2,000 ppm or less, still more preferably 1,500 ppm or less, yet still more preferably 1,000 ppm or less. When the total amount of residual volatile matters is 5,000 ppm or less, coloration due to alteration or the like at the time of molding or occurrence of a molding failure such as bubbling or silver streak is less likely, and this is preferred.

The total light transmittance of the lactone ring-containing polymer as measured by the method according to ASTM-D-1003 for a molded article obtained by injection molding is preferably 85% or more, more preferably 88% or more, still more preferably 90% or more. The total light transmittance is indicative of the transparency and when the total light transmittance is 85% or more, the transparency tends to be enhanced.

In the case of a polymerization form using a solvent, the polymerization solvent is not particularly limited but includes, for example, an aromatic hydrocarbon-based solvent such as toluene, xylene and ethylbenzene; a ketone-based solvent such as methyl ethyl ketone and methyl isobutyl ketone; an ether-based solvent such as tetrahydrofuran; and only one of these solvents may be used, or two or more thereof may be used in combination.

In a first embodiment of the production method of the present invention, the polymer is formed by dissolving a (meth)acrylic resin in an organic solvent and casting the casting and therefore, the solvent at the time of synthesis of the (meth)acrylic resin is not limited compared with a case of performing melt film formation, allowing for synthesis using a solvent having a high boiling point.

At the time of polymerization reaction, a polymerization initiator may be added, if desired. The polymerization initiator is not particularly limited and includes, for example, an organic peroxide such as cumene hydroperoxide, diisopropylbenzene hydroperoxide, di-tert-butyl peroxide, lauroyl peroxide, benzoyl peroxide, tert-butylperoxyisopropyl carbonate and tert-amylperoxy-2-ethylhexanoate; and an azo compound such as 2,2′-azobis(isobutyronitrile), 1,1′-azobis(cyclohexanecarbonitrile) and 2,2′-azobis(2,4-dimethylvaleronitrile), and only one of these compounds may be used, or two or more thereof may be used in combination. The amount of the polymerization initiator used may be appropriately set according to, for example, the combination of monomers used or the reaction conditions and is not particularly limited.

The weight average molecular weight of the polymer can be adjusted by adjusting the amount of the polymerization initiator.

When performing the polymerization, the concentration of the polymer produced in the polymerization reaction mixture is preferably controlled to be 50 mass % or less so as to suppress gelling of the reaction solution. Specifically, when the concentration of the polymer produced in the polymerization reaction mixture exceeds 50 mass %, it is preferred that a polymerization solvent is appropriately added to the polymerization reaction mixture to keep the concentration at 50 mass % or less. The concentration of the polymer produced in the polymerization reaction mixture is more preferably 45 mass % or less, still more preferably 40 mass % or less.

The form of appropriately adding a polymerization solvent to the polymerization reaction mixture is not particularly limited, and the polymerization solvent may be added continuously or intermittently. By controlling the concentration of the polymer produced in the polymerization reaction mixture in this way, the gelling of the reaction solution can be more sufficiently suppressed. The polymerization solvent added may be the same kind of solvent as the solvent used at the time of initial charging for the polymerization reaction or and may be a different kind of solvent, but it is preferable to use the same kind of solvent as the solvent used at the time of initial charging for the polymerization reaction. Also, the polymerization solvent added may be only one solvent or a mixed solvent of two or more.

### (Polymer Having an Anhydrous Glutaric Acid Ring Structure in the Main Chain)

The polymer having an anhydrous glutaric acid ring structure in the main chain is a polymer having a glutaric anhydride unit.

The polymer having a glutaric anhydride unit preferably contains a glutaric anhydride unit represented by the following formula (101) (hereinafter, referred to as the glutaric anhydride unit):

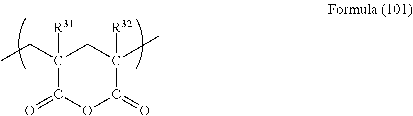

In formula (101), each of R³¹ and R³² independently represents a hydrogen atom or an organic residue having a carbon number of 1 to 20. Among others, each of R³¹ and R³² preferably represents a hydrogen atom or an alkyl group having a carbon number of 1 to 5, which is the same as or different from each other.

The polymer having a glutaric anhydride unit is preferably a (meth)acrylic polymer containing a glutaric anhydride unit. In view of heat resistance, the (meth)acrylic polymer preferably has a glass transition temperature (Tg) of 120° C. or more.

The content of the glutaric anhydride unit based on the (meth)acrylic polymer is preferably from 5 to 50 mass %, more preferably from 10 to 45 mass %. When the content is 5 mass % or more, preferably 10 mass % or more, an effect of enhancing the heat resistance can be obtained, and furthermore, an effect of enhancing the weather resistance can also be obtained.

The (meth)acrylic copolymer preferably further contains a repeating unit based on an unsaturated carboxylic acid alkyl ester. The repeating unit based on an unsaturated carboxylic acid alkyl ester is preferably, for example, a repeating unit represented by the following formula (102):

—[CH₂—C(R⁴¹)COOR⁴²]— Formula (102):

In formula (102), R⁴¹ represents hydrogen or an alkyl group having a carbon number of 1 to 5, and R⁴² represents an aliphatic or alicyclic hydrocarbon group having a carbon number of 1 to 6, or an aliphatic or alicyclic hydrocarbon group having a carbon number of 1 to 6 substituted with one or more, but not more than the carbon number, hydroxyl groups or halogens.

The monomer corresponding to the repeating unit represented by formula (102) is represented by the following formula (103):

CH₂═C(R⁴¹)COOR⁴² Formula (103):

Preferred specific examples of the monomer include methyl (meth)acrylate, ethyl (meth)acrylate, n-propyl (meth)acrylate, n-butyl (meth)acrylate, tert-butyl (meth)acrylate, n-hexyl (meth)acrylate, cyclohexyl (meth)acrylate, chloromethyl (meth)acrylate, 2-chloroethyl (meth)acrylate, 2-hydroxyethyl (meth)acrylate, 3-hydroxypropyl (meth)acrylate, 2,3,4,5,6-pentahydroxyhexyl (meth)acrylate, and 2,3,4,5-tetrahydroxypentyl (meth)acrylate, and among these, methyl methacrylate is most preferably used. One of these monomers may be used alone, or two or more thereof may be used in combination.

The content of the unsaturated carboxylic acid alkyl ester unit based on the (meth)acrylic polymer is preferably from 50 to 95 mass %, more preferably from 55 to 90 mass %. The (meth)acrylic polymer having a glutaric anhydride unit and an unsaturated carboxylic acid alkyl ester-based unit may be obtained, for example, by the cyclizing polymerization of a copolymer having an unsaturated carboxylic acid alkyl eater-based unit and an unsaturated carboxylic acid unit.

The unsaturated carboxylic acid unit is preferably, for example, a unit represented by the following formula (104):

—[CH₂—C(R⁵¹)COOH]— Formula (104):

wherein R⁵¹ represents hydrogen or an alkyl group having a carbon number of 1 to 5.

Preferred specific examples of the monomer leading to the unsaturated carboxylic acid unit include a compound represented by the following formula (105), which is a monomer corresponding to the repeating unit represented by formula (104), a maleic acid, and furthermore, a hydrolysate of maleic anhydride. In the light of excellent thermal stability, acrylic acid and methacrylic acid are preferred, and methacrylic acid is more preferred.

CH₂═C(R⁵¹)COOH Formula (105):

One of these monomers may be used alone, or two or more thereof may be used in combination. As described above, the acrylic thermoplastic copolymer having a glutaric anhydride unit and an unsaturated carboxylic acid alkyl ester-based unit can be obtained, for example, by the cyclizing polymerization of a copolymer having an unsaturated carboxylic acid alkyl eater-based unit and an unsaturated carboxylic acid unit and therefore, may have an unsaturated carboxylic acid unit remaining in its constituent unit.

The content of the unsaturated carboxylic acid unit based on the (meth)acrylic polymer is preferably 10 mass % or less, more preferably 5 mass % or less. When the content is 10 mass % or less, reduction in the colorless transparency and residence stability can be prevented.

The (meth)acrylic polymer may have aromatic ring-free other vinyl-based monomer units as long as the effects of the present invention are not impaired. Specific examples of aromatic ring-free other vinyl-based monomer units include, in terms of the corresponding monomer, a vinyl cyanide-based monomer such as acrylonitrile, methacrylonitrile and ethacrylonitrile; allyl glycidyl ether; maleic anhydride and itaconic anhydride; N-methylmaleimide, N-ethylmaleimide, N-cyclohexylmaleimide, acrylamide, methacrylamide, N-methylacrylamide, butoxymethylacrylamide and N-propylmethacrylamide; aminoethyl acrylate, propylaminoethyl acrylate, dimethylaminoethyl methacrylate, ethylaminopropyl methacrylate and cyclohexylaminoethyl methacrylate; N-vinyldiethylamine, N-acetylvinylamine, allylamine, methallylamine and N-methylallylamine; and 2-isopropenyl-oxazoline, 2-vinyl-oxazoline and 2-acroyl-oxazoline. One of these monomer units may be used alone, or two or more thereof may be used in combination.

The content of the aromatic ring-free other vinyl-based monomer unit based on the (meth)acrylic polymer is preferably 35 mass % or less.

Incidentally, an aromatic ring-containing vinyl-based monomer unit (e.g., N-phenylmaleimide, phenylaminoethyl methacrylate, p-glycidylstyrene, p-aminostyrene, 2-styryl-oxazoline) tends to reduce the scratch resistance and weather resistance and therefore, the content thereof is preferably kept at 1 mass % or less based on the (meth)acrylic polymer.

### ((Meth)Acrylic Polymer Having a Glutarimide Ring Structure in the Main Chain)

The (meth)acrylic polymer having a glutarimide ring structure in the main chain (hereinafter, sometimes referred to as the glutarimide-based resin) has a glutarimide ring structure in the main chain and thereby can bring about a preferred characteristic balance in terms of optical properties, heat resistance, etc. The (meth)acrylic polymer having a glutarimide ring structure in the main chain preferably contains at least a glutarimide resin having 20 mass % or more of a glutarimide unit represented by the following formula (301):

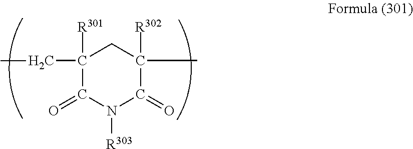

In formula (301), each of R³⁰¹, R³⁰² and R³⁰³ independently represents hydrogen, an unsubstituted or substituted alkyl group having a carbon number of 1 to 12, a cycloalkyl group, or an aryl group.

The glutarimide unit constituting the glutarimide-based resin for use in the present invention is preferably a glutarimide unit where R³⁰¹ and R³⁰² are hydrogen or a methyl group and R³⁰³ is a methyl group or a cyclohexyl group. The glutarimide unit may be a single kind of a unit or may contain a plurality of kinds of units differing in R³⁰¹, R³⁰² and R³⁰³.

A preferred second constituent unit constituting the glutarimide-based resin for use in the present invention is a unit composed of an acrylic acid ester or a methacrylic acid ester. Preferred acrylic acid ester or methacrylic acid ester constituent units include methyl acrylate, ethyl acrylate, methyl methacrylate, methyl methacrylate, etc. Other preferred imidizable units include an N-alkyl methacrylamide such as N-methyl methacrylamide and N-ethyl methacrylamide. This second constituent unit may be a single kind of a unit or may contain a plurality of kinds of units.

The content of the glutarimide unit represented by formula (301) in the glutarimide-based resin is preferably 20 mass % or more based on all repeating units in the glutarimide-based resin. The content of the glutarimide unit is more preferably from 20 to 95 mass %, more preferably from 50 to 90 mass %, still more preferably from 60 to 80 mass %. When the content of the glutarimide unit is 20 mass % or more, this is preferred from the performance aspect of heat resistance and transparency of the film obtained, and when the content is 95 mass % or less, formation into a film is facilitated and the film obtained can maintain the mechanical strength and is excellent also in terms of transparency.

In the glutarimide-based resin, a third constituent unit may be further copolymerized, if desired. As preferred examples of the third constituent unit, a constituent unit obtained by copolymerizing a styrene-based monomer such as styrene, substituted styrene and α-methylstyrene, an acrylic monomer such as butyl acrylate, a nitrile-based monomer such as acrylonitrile and methacrylonitrile, or a maleimide-based monomer such as maleimide, N-methylmaleimide, N-phenylmaleimide and N-cyclohexylmaleimide, may be used. Such a monomer may be directly copolymerized with the glutarimide unit and an imidizable unit in the glutarimide-based resin or may be graft-copolymerized to a resin containing the glutarimide unit and an imidizable unit. In the case of adding the third component, the content percentage thereof in the glutarimide-based resin is preferably from 5 to 30 mol % based on all repeating units in the glutarimide-based resin.

The glutarimide-based resin is described in U.S. Pat. Nos. 3,284,425 and 4,246,374, JP-A-2-153904, etc. and can be obtained by a method where a resin produced using a methacrylic acid methylester, etc. as the main raw material is employed as a resin having an imidizable unit and the resin having an imidizable unit is imidized using ammonia or a substituted amine. In obtaining the glutarimide-based resin, a unit composed of an acrylic acid, a methacrylic acid or an anhydride thereof is sometimes introduced as a reaction byproduct into the glutarimide-based resin. The presence of such a constituent unit, particularly, an acid anhydride, reduces the total light transmittance or haze of the obtained film of the present invention and therefore, is not preferred. The content of an acrylic acid or a methacrylic acid is desirably kept at 0.5 milliequivalent or less, preferably 0.3 milliequivalent or less, more preferably 0.1 milliequivalent or less, per 1 g of the resin. The glutarimide-based resin may also be obtained, as seen in JP-A-02-153904, by using and imidizing a resin mainly composed of N-methylacrylamide and a methacrylic acid methylester.

The glutarimide-based resin preferably has a weight average molecular weight of 1×10⁴ to 5×10⁵.

### <Ultraviolet Absorber>

The ultraviolet absorber preferably used in the substrate film is described. The polarizing plate protective film of the present invention including the substrate film may be used for a polarizing plate, a liquid crystal display member, etc. and from the standpoint of preventing deterioration of the polarizing plate, the liquid crystal cell, etc., an ultraviolet absorber is preferably used. An ultraviolet absorber having an excellent ability of absorbing an ultraviolet ray at a wavelength of 370 nm or less and, in view of good liquid crystal display property, having little absorption of visible light at a wavelength of 400 nm or more is preferably used. Only one ultraviolet absorber may be used, or two or more ultraviolet absorbers may be used in combination. The ultraviolet absorber includes, for example, the ultraviolet absorbers described in JP-A-2001-72782 and JP-T-2002-543265. Specific examples of the ultraviolet absorber include an oxybenzophenone-based compound, a benzotriazole-based compound, a salicylic acid ester-based compound, a benzophenone-based compound, a cyanoacrylate-based compound, and a nickel complex salt-based compound.

The ultraviolet absorber includes, among others, 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″,4″,5″,6″-tetrahydrophthalimidemethyl)-5′-methylphenyl)benzotriazole, 2,2-methylenebis(4-(1,1,3,3-tetramethylbutyl)-6-(2H-benzotriazol-2-yl)phenol), 2-(2′-hydroxy-3′-tert-butyl-5′-methylphenyl)-5-chlorobenzotriazole, 2,4-dihydroxybenzophenone, 2,2′-dihydroxy-4-methoxybenzophenone, 2-hydroxy-4-methoxy-5-sulfobenzophenone, bis(2-methoxy-4-hydroxy-5-benzoylphenylmethane), (2,4-bis-(n-octylthio)-6-(4-hydroxy-3,5-di-tert-butylanilino)-1,3,5-triazine, 2-(2′-hydroxy-3′,5′-di-tert-butylphenyl)-5-chlorobenzotriazole, (2(2′-hydroxy-3′,5′-di-tert-amylphenyl)-5-chlorobenzotriazole, 2,6-di-tert-butyl-p-cresol, pentaerythrityl-tetrakis[3-(3,5-di-tert-butyl-4-hydroxyphenyl)propionate], triethylene glycol-bis[3-(3-tert-butyl-5-methyl-4-hydroxyphenyl)propionate], 1,6-hexanediol-bis[3-(3,5-di-tert-butyl-4-hydroxyphenyl)propionate], 2,4-bis-(n-octylthio)-6-(4-hydroxy-3,5-di-tert-butylanilino)-1,3,5-triazine, 2,2-thio-diethylenebis[3-(3,5-di-tert-butyl-4-hydroxyphenyl)propionate], octadecyl-3-(3,5-di-tert-butyl-4-hydroxyphenyl)propionate, N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, tris-(3,5-di-tert-butyl-4-hydroxybenzyl)-isocyanurate, etc. Among these, (2,4-bis-(n-octylthio)-6-(4-hydroxy-3,5-di-tert-butylanilino)-1,3,5-triazine, 2-(2′-hydroxy-3′,5′-di-tert-butylphenyl)-5-chlorobenzotriazole, 2-(2′-hydroxy-3′,5′-di-tert-amylphenyl)-5-chlorobenzotriazole, 2,6-di-tert-butyl-p-cresol, pentaerythrityl-tetrakis[3-(3,5-di-tert-butyl-4-hydroxyphenyl)propionate] and triethylene glycol-bis[3-(3-tert-butyl-5-methyl-4-hydroxyphenyl)propionate] are preferred. Also, for example, a hydrazine-based metal deactivator such as N,N′-bis[3-(3,5-di-tert-butyl-4-hydroxyphenyl)propionyl]hydrazine or a phosphorus-based processing stabilizer such as tris(2,4-di-tert-butylphenyl)phosphite may be used in combination.

The ultraviolet absorber may also be introduced into the resin as a constituent unit having an ultraviolet absorbing ability. Examples thereof include a benzotriazole derivative, a triazine derivative or a benzophenone derivative, in which a polymerizable group is introduced. The polymerizable group introduced may be appropriately selected according to the structural unit contained in the resin.

Specific examples of the monomer include 2-(2′-hydroxy-5′-methacryloyloxy)ethylphenyl-2H-benzotriazole (trade name: RUVA-93, produced by Otsuka Chemical Co., Ltd.), 2-(2′-hydroxy-5′-methacryloyloxy)phenyl-2H-benzotriazole, and 2-(2′-hydroxy-3′-tert-butyl-5′-methacryloyloxy)phenyl-2H-benzotriazole.

### (Other Additives)

In the substrate film, additives such as matting agent, retardation developer, plasticizer, ultraviolet absorber, deterioration inhibitor, release agent, infrared absorber and wavelength dispersion adjuster may be added, and these additives may be a solid or an oily matter. That is, the additive is not particularly limited in its melting point or boiling point. For example, mixing of an ultraviolet absorbing material with a melting or boiling point of 20° C. or less and an ultraviolet absorbing material with a melting or boiling point of 20° C. or more, or mixing of plasticizers combined in the same manner may be employed, and this is described, for example, in JP-A-2001-151901. Furthermore, infrared absorbing dyes are described, for example, in JP-A-2001-194522. As for the timing of addition, the additive may be added at any time in the dope producing process, but a step of adding the additive and preparing a dope may be added as a final preparation step in the dope preparation process. The amount of the additive added is not particularly limited so long as the function is exerted. Also, in the case where the polarizing plate protective film is formed by multiple layers, the kind and amount added of the additive may differ among respective layers, which is described in JP-A-2001-151902, etc. and is a conventionally known technique. Details thereof are described in JIII Journal of Technical Disclosure (Journal of Technical Disclosure No. 2001-1745, Mar. 15, 2001, Japan Institute of Invention and Innovation), pp. 16-22, and the materials described in detail therein are preferably used.

The substrate film may also contain a rubbery particle, and examples thereof include an acrylic particle such as soft acrylic resin, acryl rubber and gum-acrylic graft-type core-shell polymer, and a styrene-elastomer copolymer. Furthermore, additives described, for example, in JP-B-60-17406 (the term “JP-B” as used herein means an “examined Japanese patent publication”) and JP-B-3-39095, which improve the impact resistance and stress whitening resistance, are also preferably used.

In the substrate film, in the case of adding such an additive, the total amount of the additives is preferably 50 mass % or less, more preferably 30 mass % or less, based on the substrate film.

Thanks to such an additive, brittleness of the film is reduced, and the performance in the folding resistance test (for example, crack evaluation at the time of 180° bending) is greatly improved.

In addition, for achieving low haze, it is preferred that the refractive index of the additive above is nearly the same as the refractive index of the substrate film, and the refractive index difference is preferably 0.5 or less, more preferably 0.3 or less.

### <Properties of Substrate Film>

### (Thickness of Substrate Film)

The thickness of the substrate film is preferably from 5 to 100 μm, more preferably from 10 to 80 μm, still more preferably from 15 to 70 μm, yet still more preferably from 20 to 60 μm. By controlling the film thickness to fall in the range above, panel unevenness accompanying a change in the environment where a liquid crystal display device is placed after stacking the low moisture-permeable layer, that is, a temperature change, can be reduced.

### (Moisture Permeability of Substrate Film)

The moisture permeability of the substrate film is measured under the condition of 40° C. and a relative humidity of 90% based on JIS Z-0208.

The moisture permeability of the substrate film is preferably 300 g/m²/day or less, more preferably 250 g/m²/day or less, still more preferably 200 g/m²/day or less, yet still more preferably 150 g/m²/day or less. By controlling the moisture permeability of the substrate film to fall in the range above, a liquid crystal display device in which a polarizing plate protective film having stacked therein a low moisture-permeability layer is mounted, can be prevented from warpage of the liquid crystal cell or light leakage after aging in an ordinary temperature environment, in a high-humidity environment or in a high-temperature high-humidity environment.

### (Moisture Permeability Per Unit Film Thickness of Substrate Film)

As described in (Moisture Permeability Per Unit Film Thickness) of the low moisture-permeable layer, the moisture permeability of the substrate film 10 μm is afforded by the following formula:

Cₛ(10 μm)=Jₛ×dₛ/10 [g/m²/day]

(wherein dₛ [μm] is the thickness of the substrate film, and Jₛ is the moisture permeability of the substrate film).

The moisture permeability relative to a substrate film thickness of 10 μm is preferably from 50 to 2,000 g/m²/day, more preferably from 80 to 1,500 g/m²/day, still more preferably from 100 to 1,000 g/m²/day, yet still more preferably from 150 to 800 g/m²/day (the moisture permeability is a value after the passing of 24 hours at 40° C. and a relative humidity of 90% according to JIS Z-0208).

Also, the ratio C_{b}(10 μm)/Cₛ(10 μm) of moisture permeability relative to a film thickness of 10 μm between the substrate film and the low moisture-permeable layer is preferably from 1.5 to 30, more preferably from 2 to 20, still more preferably from 3 to 10.

With a value not less than the lower limit value, a sufficient effect of lowering the moisture permeation is obtained, and with a value not more than the upper limit value, curling can be prevented.

### (Oxygen Permeation Coefficient of Substrate Film)

In order to reduce the moisture permeability, it is preferable to suppress the diffusion of water in the film, that is, to decrease the free volume of the film. In general, the free volume of the film correlates to the oxygen permeation coefficient of the film.

The oxygen permeation coefficient of the substrate film is preferably 100 cc·mm/(m²·day·atm) or less, more preferably 30 cc·mm/(m²·day·atm) or less.

### (Surface Treatment)

Depending on the case, the substrate film can achieve enhancement of the adhesion of the substrate film to the low moisture-permeable layer or other layers (for example, a polarizer, an undercoat layer or a back layer) by performing a surface treatment. For example, a glow discharge treatment, an ultraviolet irradiation treatment, a corona treatment, a flame treatment, and an acid or alkali treatment may be used. The glow discharge treatment as used herein may be a treatment with low-temperature plasma occurring in a low-pressure gas of 10⁻³ to 20 Torr, and furthermore, a plasma treatment under atmospheric pressure is also preferred. The plasma-exciting gas indicates a gas excited by plasma under the above-described conditions and includes, for example, argon, helium, neon, krypton, xenon, nitrogen, carbon dioxide, fluorocarbons such as tetrafluoromethane, and a mixture thereof. Details thereof are described in JIII Journal of Technical Disclosure (Journal of Technical Disclosure No. 2001-1745, Mar. 15, 2001, Japan Institute of Invention and Innovation), pp. 30-32, and those described therein can be preferably used in the present invention.

### (Thickness of Polarizing Plate Protective Film)

The thickness of the polarizing plate protective film of the present invention is preferably from 5 to 100 more preferably from 10 to 80 still more preferably from 15 to 75 μm.

### [Optical Film]

The polarizing plate protective film of the present invention preferably further has a hardcoat layer on the layer formed by during the curable composition containing (A) and (B) (low moisture-permeable layer). Hereinafter, a laminate having a low moisture-permeable layer and a hardcoat layer on the substrate film is sometimes referred to as an optical film.

### [Properties of Optical Film]

### [Layer Configuration of Optical Film]

The optical film above is a laminate having a low moisture-permeable layer and a hardcoat layer on one surface of the substrate film and is preferably used as a surface film of a liquid crystal display device. That is, in the present invention, for suitably using the polarizing plate protective film as a surface film of a liquid crystal display device, the polarizing plate protective film is preferably fabricated as an optical film having a hardcoat layer on the low moisture-permeable layer. Preferred layer configurations of the optical film are recited below.

Substrate film/low moisture-permeable layer/hardcoat layer

Substrate film/adherence layer/low moisture-permeable layer/hardcoat layer

Substrate film/low moisture-permeable layer/hardcoat layer/antireflection layer

Substrate film/low moisture-permeable layer/hardcoat layer/antireflection layer/antifouling layer

### [Hardcoat Layer]

The polarizing plate protective film of the present invention preferably has a hardcoat layer.

The hardcoat layer as used in the present invention indicates a layer indicates a hardcoat layer capable of increasing the pencil hardness of the film (imparting a hardcoat property) by forming the hardcoat layer on the film. The hardcoat layer is not particularly limited as long as it is a layer capable of imparting the hardcoat property, and the hardcoat layer may be a layer having a function other than a hardcoat property and encompasses, for example, an antiglare hardcoat layer (sometimes referred to as an antiglare layer), an antistatic hardcoat layer (sometimes referred to as an antistatic layer), etc. For practical purposes, the pencil hardness (JIS K-5400-5-1) after stacking the hardcoat layer is preferably H or more, more preferably 2H or more, and most preferably 3H or more.

The thickness of the hardcoat layer is preferably from 0.4 to 35 μm, more preferably from 1 to 30 μm, and most preferably from 1.5 to 20 μm.

In the present invention, the hardcoat layer may be one layer or may be a plurality of layers. In the case where the hardcoat layer is a plurality of layers, the total of thicknesses of all hardcoat layers is preferably in the range above.

The surface of the hardcoat layer of the optical film may be flat or uneven. Also, if desired, a light-transmitting particle may be incorporated into the hardcoat layer to impart surface unevenness or internal scattering.

### [Hardcoat Layer-Forming Material]

In the present invention, the hardcoat layer can be formed by subjecting a composition containing an ethylenically unsaturated double bond-containing compound and a polymerization initiator and, if desired, containing a light-transmitting particle, a fluorine-containing or silicone-based compound and a solvent to coating, drying and curing on a support directly or through another layer. Respective components are described below.

### [Compound Having Ethylenically Unsaturated Double Bond]

In the present invention, the hardcoat layer-forming composition may contain a compound having an ethylenically unsaturated double bond. The compound having an ethylenically unsaturated double bond is preferably a polyfunctional monomer having two or more polymerizable unsaturated groups. By using the polyfunctional monomer having two or more polymerizable unsaturated groups, the strength or scratch resistance of the coating film can be enhanced. The number of polymerizable unsaturated groups is more preferably 3 or more. As for these monomers, a monofunctional or bifunctional monomer and a trifunctional or higher functional monomer may also be used in combination.

The compound having an ethylenically unsaturated double bond includes a compound having a polymerizable functional group such as (meth)acryloyl group, vinyl group, styryl group and allyl group. Among others, a (meth)acryloyl group and —C(O)OCH═CH₂ are preferred. In particular, the following compounds containing three or more (meth)acryloyl groups per one molecule may be preferably used.

Specific examples of the compound having a polymerizable unsaturated bond include (meth)acrylic acid diesters of an alkylene glycol, (meth)acrylic acid diesters of a polyoxyalkylene glycol, (meth)acrylic acid esters of a polyhydric alcohol, (meth)acrylic acid esters of an ethylene oxide or propylene oxide adduct, epoxy (meth)acrylates, urethane (meth)acrylates, and polyester (meth)acrylates.

Among others, esters of a polyhydric alcohol with a (meth)acrylic acid are preferred. Examples thereof include 1,4-butanediol di(meth)acrylate, 1,6-hexanediol di(meth)acrylate, neopentyl glycol (meth)acrylate, ethylene glycol di(meth)acrylate, triethylene glycol di(meth)acrylate, pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphoric acid tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, 1,2,3-cyclohexane tetramethacrylate, polyurethane polyacrylate, polyester polyacrylate, and caprolactone-modified tris(acryloxyethyl)isocyanurate.

As the polyfunctional acrylate-based compounds having a (meth)acryloyl group, a commercially available product may be used, and examples thereof include NK Ester A-TMMT produced by Shin-Nakamura Chemical Co., Ltd., and KAYARAD DPHA produced by Nippon Kayaku Co., Ltd. The polyfunctional monomer is described in paragraphs [0114] to [0122] of JP-A-2009-98658, and the same applies to the present invention.

The compound having an ethylenically unsaturated double bond is preferably a compound having a hydrogen-bonding substituent in terms of adherence to support, low curl, and fixedness of the later-described fluorine-containing or silicon-based compound. The hydrogen-bonding substituent indicates a substituent in which an atom having high electronegativity, such as nitrogen, oxygen, sulfur and halogen, is covalently bonded to a hydrogen bond, and specifically includes OH—, SH—, —NH—, CHO—, CHN—, etc. Urethane (meth)acrylates and (meth)acrylates having a hydroxyl group are preferred. A commercially available polyfunctional acrylate having a (meth)acryloyl group may also be used, and examples thereof include NK Oligo U4HA and NK Ester A-TMM-3, both produced by Shin-Nakamura Chemical Co., Ltd., and KAYARAD PET-30 produced by Nippon Kayaku Co., Ltd.

In order to achieve a sufficient polymerization and thereby impart hardness, etc., the content of the compound having an ethylenically unsaturated double bond in the hardcoat layer-forming composition is preferably 50 mass % or more, more preferably from 60 to 99 mass %, still more preferably from 70 to 99 mass %, yet still more preferably from 80 to 99 mass %, based on the total solid content excluding inorganic components in the hardcoat layer-forming composition.

In the present invention, a compound having a cyclic aliphatic hydrocarbon and an ethylenically unsaturated double bond in the molecule is also preferably used in the hardcoat layer-forming composition. By using such a compound, low moisture permeability can be imparted to the hardcoat layer. In order to enhance the hardcoat property, it is more preferable to use a compound having, in the molecular, a cyclic aliphatic hydrocarbon and two or more ethylenically unsaturated double bonds.

In the case where the hardcoat layer-forming composition contains a compound having a cyclic aliphatic hydrocarbon and an ethylenically unsaturated double bond in the molecule, the content of the compound having a cyclic aliphatic hydrocarbon and an ethylenically unsaturated double bond in the molecule is preferably from 1 to 90 mass %, more preferably from 2 to 80 mass %, still more preferably from 5 to 70 mass %, based on the ethylenically unsaturated double bond-containing compound in the hardcoat layer-forming composition.

In the case where the hardcoat layer-forming composition contains a compound having a cyclic aliphatic hydrocarbon and an ethylenically unsaturated double bond in the molecule, it is preferable to further contain a pentafunctional or higher functional (meth)acrylate.

In the case where the hardcoat layer-forming composition further contains a pentafunctional or higher functional (meth)acrylate, the content of the pentafunctional or higher functional (meth)acrylate is preferably from 1 to 70 mass %, more preferably from 2 to 60 mass %, still more preferably from 5 to 50 mass %, based on the ethylenically unsaturated double bond-containing compound in the hardcoat layer-forming composition.

### [Light-Transmitting Particle]

In the present invention, a light-transmitting particle may be incorporated into the hardcoat layer to thereby impart a concavoconvex shape to the hardcoat layer surface or impart internal haze.

The light-transmitting particle that can be used in the hardcoat layer includes, for example, a crosslinked poly((meth)acrylate) particle such as polymethyl methacrylate particle (refractive index: 1.49), a crosslinked poly(acryl-styrene) copolymer particle (refractive index: 1.54), a melamine resin particle (refractive index: 1.57), a polycarbonate particle (refractive index: 1.57), a polystyrene particle (refractive index: 1.60), a crosslinked polystyrene particle (refractive index: 1.61), a polyvinyl chloride particle (refractive index: 1.60), a benzoguanamine-melamine formaldehyde particle (refractive index: 1.68), a silica particle (refractive index: 1.46), an alumina particle (refractive index: 1.63), a zirconia particle, a titania particle, and a particle having a hollow or a pore.

Among these, a crosslinked poly((meth)acrylate) particle and a crosslinked poly(acryl-styrene) particle are preferably used, and by adjusting the refractive index of the binder according to the refractive index of each light-transmitting particle selected from these particles, surface unevenness, surface haze, internal haze and total haze, which are suitable for the hardcoat layer of the optical film, can be achieved.

The refractive index of the binder (light-transmitting resin) is preferably from 1.45 to 1.70, more preferably 1.48 to 1.65.

Also, the refractive index difference between the light-transmitting particle and the binder of the hardcoat layer (“refractive index of light-transmitting particle”—“refractive index of hardcoat layer excluding the light-transmitting particle”) is, in terms of an absolute value, preferably less than 0.05, more preferably from 0.001 to 0.030, still more preferably from 0.001 to 0.020. When the refractive index difference between the light-transmitting particle and the binder in the hardcoat layer is less than 0.05, the refraction angle of light is decreased by the light-transmitting particle and the scattered light does not extend to a wide angle and does not produce a deteriorating action such as depolarization of transmitted light of an optically anisotropic layer, which is preferred.

In order to realize the above-described refractive index difference between the particle and the binder, the refractive index of the light-transmitting particle may be adjusted, or the refractive index of the binder may be adjusted.

A preferred first embodiment is to use, in combination, a binder (refractive index after curing: from 1.50 to 1.53) containing a trifunctional or higher functional (meth)acrylate monomer as the main component and a light-transmitting particle composed of a crosslinked poly(meth)acrylate/styrene polymer having an acrylic content percentage of 50 to 100 mass %. The refractive index difference between the light-transmitting particle and the binder can be easily adjusted to less than 0.05 by adjusting the composition ratio of the acryl component having a low refractive index to the styrene component having a high refractive index. The ratio of the acryl component to the styrene component is, in mass ratio, preferably from 50/50 to 100/0, more preferably from 60/40 to 100/0, and most preferably from 65/35 to 90/10. The refractive index of the light-transmitting particle composed of a crosslinked poly(meth)acrylate/styrene polymer is preferably from 1.49 to 1.55, more preferably from 1.50 to 1.54, and most preferably from 1.51 to 1.53.

A second preferred embodiment is to use an inorganic fine particle having an average particle size of 1 to 100 nm in combination with a binder containing, as the main component, a trifunctional or higher functional (meth)acrylate monomer having three or more functional groups, where the refractive index of the binder composed of the monomer and the inorganic fine particle is adjusted to thereby adjust the refractive index difference from the existing light-transmitting particle. The inorganic particle includes an oxide of at least one metal selected from silicon, zirconium, titanium, aluminum, indium, zinc, tin and antimony, and specific examples thereof include SiO₂, ZrO₂, TiO₂, Al₂O₃, In₂O₃, ZnO, SnO₂, Sb₂O₃, and ITO, with SiO₂, ZrO₂ and Al₂O₃ being preferred. The inorganic particle can be used by mixing such an inorganic particle in an amount of 1 to 90 mass % based on the total amount of monomers, and the amount used is preferably from 5 to 65 mass %.

Here, the refractive index of the hardcoat layer excluding the light-transmitting particle can be quantitatively evaluated, for example, by directly measuring it with an Abbe refractometer or by measuring spectral reflectance spectrum or spectral ellipsometry. The refractive index of the light-transmitting particle is measured by a method where the light-transmitting particles are dispersed in equal amounts in solvents prepared by changing the mixing ratio of two kinds of solvents differing in the refractive index and thereby varying the refractive index, the turbidity is measured, and the refractive index of the solvent when the turbidity becomes minimum is measured by an Abbe refractometer.

The average particle diameter of the light-transmitting particle is preferably from 1.0 to 12 μm, more preferably from 3.0 to 12 μm, still more preferably from 4.0 to 10.0 μm, and most preferably from 4.5 to 8 μm. By setting the refractive index difference and the particle size to the ranges above, the distribution of scattered light angles does not extend to a wide angle, and blurring of characters or contrast reduction on the display is less likely to occur. From the standpoint that the film thickness of the layer to which the particle added need not be increased and a problem of curl or rise in cost can be hardly caused, the particle diameter is preferably 12 μm or less. Furthermore, a particle diameter in the above-described range is preferred in that the amount coated at the time of coating can be reduced, the drying is completed fast, and a planar defect such as drying unevenness scarcely occurs.

As for the method for measuring the average particle diameter of the light-transmitting particle, any measurement method may be applied as long as it is a method for measuring the average particle diameter of particles, but preferably, 100 particles are observed by observing the particle through a transmission electron microscope (magnification: from 500,000 to 2,000,000 times) and the average value thereof can be taken as the average particle diameter.

The shape of the light-transmitting particle is not particularly limited, but, other than a truly spherical particle, a light-transmitting particle differing in the shape, such as irregularly shaped particle (e.g., non-truly spherical particle), may also be used in combination. In particular, when short axes of non-truly spherical particles are aligned in the normal direction of the hardcoat layer, a particle having a small particle diameter as compared with a truly spherical particle can be used.

The light-transmitting particle is preferably blended to be contained in an amount of 0.1 to 40 mass %, more preferably from 1 to 30 mass %, still more preferably from 1 to 20 mass %, based on the total solid content of the hardcoat layer. By setting the blending ratio of the light-transmitting particle to the range above, the internal haze can be controlled to a preferred range.

The amount of the light-transmitting particle coated is preferably from 10 to 2,500 mg/m², more preferably from 30 to 2,000 mg/m², still more preferably from 100 to 1,500 mg/m².

### <Preparation and Classification Methods of Light-Transmitting Particle>

The production method of the light-transmitting particle includes a suspension polymerization method, an emulsion polymerization method, a soap-free emulsion polymerization method, a dispersion polymerization method, a seed polymerization method, etc., and the particle may be produced by any of these methods. As for these production methods, reference may be made, for example, to the description in “Kobunshi Gosei no Jikken-ho (Experimental Method of Polymer Synthesis” (co-authored by Takayuki Otsu and Masayoshi Kinoshita, Kagaku-Dojin Sha), pages 130, 146 and 147, the methods described in “Gousei Kobunshi (Synthetic Polymer)” Vol. 1, pp. 246-290, and ibid., Vol. 3, pp. 1-108, and the methods described in Japanese Patents 2,543,503, 3,508,304, 2,746,275, 3,521,560, 3,580,320, JP-A-10-1561, JP-A-7-2908, JP-A-5-297506 and JP-A-2002-145919.

As regards the particle size distribution of the light-transmitting particle, a monodisperse particle is preferred in view of the control of haze value and diffusibility and the uniformity of coated surface property. The CV value indicative of uniformity of the particle size is preferably 15% or less, more preferably 13% or less, still more preferably 10% or less. Furthermore, when a particle having a particle size 20% or more larger than the average particle size is specified as a coarse particle, the proportion of the coarse particle is preferably 1% or less, more preferably 0.1% or less, still more preferably 0.01% or less, based on the total number of particles. For obtaining particles having such a particle size distribution, it is an effective method to classify the particles after the preparation or synthesis reaction thereof, and particles having a desired distribution can be obtained by increasing the number of classifications or by intensifying the degree of classification.

The classification preferably uses a method such as air classification method, centrifugal classification method, sedimentation classification method, filtration classification method or electrostatic classification method.

In nor to adjust the viscosity of the coating solution, a thickening agent may be used.

The thickening agent as used herein means a substance capable of increasing the viscosity of a solution when added.

The thickening agent includes, but is not limited to, the followings:
poly-ε-caprolactone,
poly-ε-caprolactone diol,
poly-ε-caprolactone triol,
polyvinyl acetate,
poly(ethylene adipate),
poly(1,4-butylene adipate),
poly(1,4-butylene glutarate),
poly(1,4-butylene succinate),
poly(1,4-butylene terephthalate),
poly(ethylene terephthalate),
poly(2-methyl-1,3-propylene adipate),
poly(2-methyl-1,3-propylene glutarate),
poly(neopentyl glycol adipate),
poly(neopentyl glycol sebacate),
poly(1,3-propylene adipate),
poly(1,3-propylene glutarate),
polyvinylbutyral,
polyvinylformal,
polyvinylacetal,
polyvinylpropanal,
polyvinylhexanal,
polyvinylpyrrolidone,
polyacrylic acid ester,
polymethacrylic acid ester,
cellulose acetate,
cellulose propionate, and
cellulose acetate butyrate.

Other than these, known viscosity adjusting agents or thixotropy imparting agents, for example, a layered compound such as smectite, mica, bentonite, silica and montmorillonite, and sodium polyacrylate described in JP-A-8-325491; and ethyl cellulose, polyacrylic acid and organic clay described in JP-A-10-219136, may be used. The thixotropy imparting agent is preferably, among others, a compound obtained by an organification treatment of a layered compound having a particle diameter of 0.3 μm or less. A layered compound having a particle diameter of 0.1 μm or less is more preferred. The particle diameter of the layered compound can be converted from the length of the long axis. Usually, the amount of the compound is preferably on the order of 1 to 10 parts by mass per 100 parts by mass of the ultraviolet-curable resin.

### [Photopolymerization Initiator]

It is also preferable to incorporate a photopolymerization initiator into the hardcoat layer-forming composition. The photopolymerization initiator described in the low moisture-permeable layer can also be preferably used in the hardcoat layer-forming composition.

The content of the photopolymerization initiator in the hardcoat layer-forming composition is preferably from 0.5 to 8 mass %, more preferably from 1 to 5 mass %, based on the total solid content in the hardcoat layer-forming composition, for the reason that the content is sufficiently large to polymerize a polymerizable compound contained in the hardcoat layer-forming composition and at the same time, small enough to prevent an excessive increase of initiation sites.

### [Ultraviolet Absorber]

The polarizing plate protective film of the present invention can be used for a polarizing plate or a liquid crystal display device member, but from the standpoint of preventing deterioration of a polarizing plate, a liquid crystal cell, etc., the polarizing plate protective film having a hardcoat layer may also be imparted with ultraviolet absorptivity by incorporating an ultraviolet absorber into the hardcoat layer as long as UV curing is not inhibited.

### [Solvent]

In the present invention, the hardcoat layer-forming composition may contain a solvent. As the solvent, various solvents may be used by taking into account the solubility of monomer, the dispersibility of light-transmitting particle, the drying property during coating, and the like. Such an organic solvent includes, for example, dibutyl ether, dimethoxyethane, diethoxyethane, propylene oxide, 1,4-dioxane, 1,3-dioxolane, 1,3,5-trioxane, tetrahydrofuran, anisole, phenetole, dimethyl carbonate, methyl ethyl carbonate, diethyl carbonate, acetone, methyl ethyl ketone (MEK), diethyl ketone, dipropyl ketone, diisobutyl ketone, cyclopentanone, cyclohexanone, methylcyclohexanone, ethyl formate, propyl formate, pentyl formate, methyl acetate, ethyl acetate, propyl acetate, methyl propionate, ethyl propionate, γ-butyrolactone, methyl 2-methoxyacetate, methyl 2-ethoxyacetate, ethyl 2-ethoxyacetate, ethyl 2-ethoxypropionate, 2-methoxyethanol, 2-propoxyethanol, 2-butoxyethanol, 1,2-diacetoxyacetone, acetylacetone, diacetone alcohol, methyl acetoacetate, ethyl acetoacetate, methyl alcohol, ethyl alcohol, isopropyl alcohol, n-butyl alcohol, cyclohexyl alcohol, isobutyl acetate, methyl isobutyl ketone (MIBK), 2-octanone, 2-heptanone, 2-hexanone, ethylene glycol ethyl ether, ethylene glycol isopropyl ether, ethylene glycol butyl ether, propylene glycol methyl ether, ethyl carbitol, butyl carbitol, hexane, heptane, octane, cyclohexane, methylcyclohexane, ethylcyclohexane, benzene, toluene, and xylene. One of these solvents may be used alone, or two or more thereof may be used in combination.

In the present invention, the solvent is preferably used such that the solid content concentration of the hardcoat layer-forming composition becomes from 20 to 80 mass %, more preferably from 30 to 75 mass %, still more preferably from 40 to 70 mass %.

### {Functional Layer}

In the present invention, the optical film may further has a functional layer. The functional layer is not particularly limited in its kind but includes an antireflection layer (a layer where the refractive index is adjusted, such as low refractive index layer, medium refractive index layer and high refractive index layer), an antiglare layer, an antistatic layer, an ultraviolet absorbing layer, an adherence layer (a layer for enhancing the adherence between the substrate film and the low moisture-permeable layer), etc.

One of these functional layers may be provided, or a plurality of layers thereof may be provided. The method for stacking the functional layer is not particularly limited.

The functional layer may be stacked on a surface where the low moisture-permeable layer is not stacked.

### [Antireflection Layer]

It is also a preferred embodiment of the present invention to stack an antireflection layer on a hardcoat layer as described above. In the present invention, a known antireflection layer may be preferably used, but among other, an antireflection layer of a UV-curable type is preferred.

The antireflection layer may be a low reflectance layer with a film thickness of λ/4 consisting of one layer or may have a multilayer configuration, but a low reflectance layer with a film thickness of 214 consisting of one layer is preferred. The low refractive material that can be preferably used in the present invention is described below, but the present invention is not limited thereto.

### [Material of Low Refractive Index Layer]

The material of the low refractive index layer is described below.

### [Inorganic Fine Particle]

From the standpoint of reducing the refractive index and improving the scratch resistance, it is preferable to use an inorganic fine particle in the low refractive index layer. The inorganic fine particle is not particularly limited as long as the average particle size is from 5 to 120 nm, but in view of reducing the refractive index, an inorganic low-refractive-index particle is preferred.

The inorganic fine particle includes, because of low refractive index, a magnesium fluoride fine particle and a silica fine particle. Among others, in terms of refractive index, dispersion stability and cost, a silica fine particle is preferred. The size (primary particle diameter) of the inorganic particle is preferably from 5 to 120 nm, more preferably from 10 to 100 nm, from 20 to 100 nm, and most preferably from 30 to 90 nm.

When the particle diameter of the inorganic fine particles is 5 nm or more, the effect of improving the scratch resistance is increased, and when the particle diameter is 120 nm or less, fine irregularities are not generated on the low refractive index layer surface and the denseness of black, appearance or integrated reflectance is not deteriorated.

The inorganic fine particle may be either crystalline or amorphous and may be a monodisperse particle or even an aggregate particle as long as the predetermined particle diameter is satisfied. The shape is most preferably spherical but may be indefinite.

The amount of the inorganic fine particle coated is preferably from 1 to 100 mg/m², more preferably from 5 to 80 mg/m², still more preferably from 10 to 60 mg/m². If the coated amount is too small, sufficient reduction in the refractive index cannot be expected or the effect of improving the scratch resistance may decrease, whereas if it is too large, fine irregularities are generated on the low refractive index layer surface and the appearance such as denseness of black or the integrated reflectance may be deteriorated.

### (Porous or Hollow Fine Particle)

In order to reduce the refractive index, a fine particle having a porous or hollow structure is preferably used. Among others, it is preferable to use a silica particle having a hollow structure. The porosity of the particle is preferably from 10 to 80%, more preferably from 20 to 60%, and most preferably from 30 to 60%. Keeping the porosity of the hollow fine particle in the above-described range is preferred from the standpoint of reducing the refractive index and maintaining the durability of the particle.

When the particle diameter of the hollow silica fine particle is 5 nm or more, a sufficient proportion of void parts can be ensured, and the refractive index can be reduced. Similarly to the inorganic fine particle described above, the upper limit is preferably 120 nm or less.

In the case where the porous or hollow particle is silica, the refractive index of the fine particle is preferably from 1.10 to 1.40, more preferably from 1.15 to 1.35, and most preferably from 1.15 to 1.30. This refractive index indicates a refractive index of the particle as a whole and does not indicate a refractive index of only silica in the outer shell forming the silica particle.

In addition, two or more kinds of hollow silica particles differing in the average particle size can be used in combination. The average particle diameter of the hollow silica particle can be determined from an electron micrograph.

In the present invention, the specific surface area of the hollow silica is preferably from 20 to 300 m²/g, more preferably from 30 to 120 m²/g, and most preferably from 40 to 90 m²/g. The surface area can be determined by a BET method using nitrogen.

In the present invention, a void-free silica particle may be used in combination with the hollow silica. The particle size of the void-free silica is preferably from 30 to 150 nm, more preferably from 35 to 100 nm, and most preferably from 40 to 80 nm.

### [Method for Surface Treatment of Inorganic Fine Particle]

Also, in the invention, the inorganic fine particle can be used after surface treatment with a silane coupling agent, etc., in a conventional manner.

Particularly, in order to improve the dispersibility in the binder for the formation of a low refractive index layer, the surface of the inorganic fine particles is preferably treated with a hydrolysate of an organosilane compound and/or a partial condensate thereof, and it is more preferred that either one or both of an acid catalyst and a metal chelate compound are used in the treatment. The method for the surface treatment of the inorganic fine particles is described in paragraphs [0046] to [0076] of JP-A-2008-242314, and the organosilane compound, siloxane compound, solvent for surface treatment, catalyst for surface treatment, metal chelate compound, etc. described in this publication can be suitably used also in the present invention.

In the low refractive index layer, (b2) a fluorine-containing or fluorine-free monomer having a polymerizable unsaturated group may be used. As the fluorine-free monomer, the compounds having an ethylenically unsaturated double bond described as the compound usable in the hardcoat layer are also preferable used. As the fluorine-containing monomer, it is preferable to use (d) a fluorine-containing polyfunctional monomer represented by the following formula (1), containing 35 mass % or more of fluorine, where the calculated value of all inter-crosslinking molecular weights is less than 500:

Rf₂{-(L)ₘ-Y}ₙ Formula (1):

(wherein in formula (1), Rf₂ represents an n-valent group containing at least a carbon atom and a fluorine atom, n represents an integer of 3 or more, L represents a single bond or a divalent linking group, m represents 0 or 1, and Y represents a polymerizable unsaturated group).

Rf₂ may contain at least either an oxygen atom or a hydrogen atom. Also, Rf₂ is chained (linear or branched) or cyclic.

Y is preferably a group containing two carbon atoms forming an unsaturated bond, more preferably a radical-polymerizable group, still more preferably a group selected from a (meth)acryloyl group, an allyl group, an α-fluoroacryloyl group and —C(O)OCH═CH₂. Among these, in view of polymerizability, a (meth)acryloyl group, an allyl group, an α-fluoroacryloyl group, and C(O)OCH═CH₂, each having radical polymerizability, are preferred.

L represents a divalent linking group and specifically represents an alkylene group having a carbon number of 1 to 10, an arylene group having a carbon number of 6 to 10, —O—, —S—, —N(R)—, a group obtained by combining an alkylene group having a carbon number of 1 to 10 and —O—, —S— or N(R)—, or a group obtained by combining an arylene group having a carbon number of 6 to 10 and —O—, —S— or N(R)—. R represents a hydrogen atom or an alkyl group having a carbon number of 1 to 5. In the case where L represents an alkylene group or an arylene group, the alkylene group or arylene group represented by L is preferably substituted with a halogen atom, more preferably with a fluorine atom.

Specific examples of the compound represented by formula (1) are described in paragraphs [0121] to [0163] of JP-A-2010-152311.

### [Optically Anisotropic Layer]

In the present invention, an optically anisotropic layer may also be provided in the optical film. The optically anisotropic layer may be an optically anisotropic layer where a film having certain retardation is formed uniformly in plane, or an optically anisotropic layer having formed therein a pattern such that retardation regions differing in the direction of slow axis or the amount of retardation from each other are regularly arranged in plane.

As described above, the optical film is preferably a surface film having stacked therein a hardcoat layer, of a liquid crystal display device. In the present invention, in the case where the optical film has both a hardcoat layer and an optically anisotropic layer, the optically anisotropic layer is preferably formed, through the substrate film, on a surface in which a hardcoat layer is not formed.

In the optical film having such an embodiment, the low moisture-permeable layer may be stacked on the same side as the hardcoat layer relative to the substrate film, may be provided on the side opposite the hardcoat layer, or may be stacked on both surfaces of the substrate film.

As for the preferred layer configuration in the case of stacking the low moisture-permeable layer on the same side as the hardcoat layer relative to the substrate film, the above-described preferred layer configuration when stacking a hardcoat layer may be employed.

On the other hand, in the case where the low moisture-permeable layer is stacked on the same side as the hardcoat layer and the optically anisotropic layer relative to the substrate film, the low moisture-permeable layer may be stacked between the substrate film and the optically anisotropic layer, or the substrate film, the optically anisotropic layer and the low moisture-permeable layer may be stacked in this order.

The materials and production conditions of the optically anisotropic layer may be selected according to various uses, but in the present invention, an optically anisotropic layer using a polymerizable liquid crystalline compound is preferred. In this case, it is also a preferred embodiment that an alignment film is formed between the optically anisotropic layer and the substrate film in such a manner as to contact with the optically anisotropic layer.

Preferred examples of the film having an optically anisotropic layer formed uniformly in plane include an embodiment where the optically anisotropic layer is a 214 film, and this embodiment is useful in particular for a member of an active 3D liquid crystal display device. The embodiment where a λ/4 film as an optically isotropic layer and a hardcoat layer are stacked on opposite surfaces through a substrate film is described in JP-A-2012-098721 and JP-A-2012-127982, and such an embodiment may be preferably used in the polarizing plate protective film of the present invention.

On the other hand, preferred examples of the optically anisotropic layer having formed therein a pattern includes a pattern-type 2-14 film, and the embodiments described in Japanese Patents 4,825,934 and 4,887,463 may be preferably used in the polarizing plate protective film of the present invention.

In addition, the embodiment described in JP-T-2012-517024 (WO2010/090429), where a photo-alignment film and patternwise exposure are combined, may also be preferably used in the polarizing plate protective film of the present invention.

[Layer Configuration of Optical Film when Having Optically Anisotropic Layer]

Preferred layer configurations in the present invention when the optical film has an optically anisotropic layer are recited below:

optically anisotropic layer/substrate film/low moisture-permeable layer/hardcoat layer,

optically anisotropic layer/substrate film/adherence layer/low moisture-permeable layer/hardcoat layer,

optically anisotropic layer/substrate film/low moisture-permeable layer/hardcoat layer/antireflection layer, and

optically anisotropic layer/substrate film/adherence layer/low moisture-permeable layer/hardcoat layer/antireflection layer.

In the case of having an optically anisotropic layer, the optical anisotropy is preferably brought about by a liquid crystal compound having a curable group such as unsaturated polymerizable group, and an alignment film is preferably formed under a liquid crystal layer. In the present invention, it is also preferred that the alignment film is formed of a curable composition containing a radical polymerizable compound.

### [Polarizing Plate]

The polarizing plate of the present invention is characterized by including a polarizer and at least one polarizing plate protective film of the present invention as a protective film of the polarizer.

In the present invention, the method for manufacturing the polarizing plate is not particularly limited, and the polarizing plate can be manufactured by a general method. There is a method where the obtained polarizing plate protective film is alkali-treated and laminated to both surfaces of a polarizer produced by dipping a polyvinyl alcohol film in an iodine solution and stretching the film, by using an aqueous completely saponified polyvinyl alcohol solution. In place of an alkali treatment, an easy adhesion processing may be applied as described in JP-A 6-94915 and JP-A-6-118232. Alternatively, the above-described surface treatment may be performed. The polarizing plate protective film surface laminated to the polarizer may be the surface where the low moisture-permeable layer is stacked, or a surface where the low moisture-permeable layer is not stacked.

The adhesive used for laminating together the treated surface of the protective film and the polarizer includes, for example, a polyvinyl alcohol-based adhesive such as polyvinyl alcohol and polyvinylbutyral, and a vinyl-based latex such as butyl acrylate.

The polarizing plate consists of a polarizer and protective films for protecting both surfaces thereof and is configured such that a protect film is laminated to one surface of the polarizing plate and a separate film is laminated to the opposite surface. The protective film and separate film are used for the purpose of protecting the polarizing plate at the time of shipment of the polarizing plate, product inspection, etc. In this case, the protective film is laminated for the purpose of protecting the surface of the polarizing plate and is used on the side opposite the polarizing plate surface laminated to a liquid crystal plate. Also, the separate film is used for the purpose of covering the adhesive layer laminated to a liquid crystal plate and is used on the polarizing plate surface laminated to a liquid crystal plate.

### [Liquid Crystal Display Device]

The liquid crystal display device of the present invention is characterized by including a liquid crystal cell and the polarizing plate of the present invention disposed on at least one surface of the liquid crystal cell, wherein the polarizing plate protective film of the present invention contained in the polarizing plate is disposed to become an outermost surface layer.

### (Configuration of General Liquid Crystal Display Device)

A liquid crystal display device has a configuration consisting of a liquid crystal cell carrying a liquid crystal between two electrode substrates and two polarizing plates disposed on both sides thereof, where, if desired, at least one optically compensatory film is disposed between the liquid crystal cell and the polarizing plate.

The liquid crystal layer of the liquid crystal cell is usually formed by encapsulating a liquid crystal in a space formed by interposing a spacer between two substrates. A transparent electrode layer is formed, on a substrate, as a transparent film containing an electrically conductive substance. In the liquid crystal cell, a gas barrier layer, a hardcoat layer or an undercoat layer (subbing layer) (used for adhesion of the transparent electrode layer) may be further provided. Such a layer is usually provided on the substrate. The substrate of the liquid crystal cell generally has a thickness of 50 μm to 2 mm.

In a liquid crystal display device, a substrate containing a liquid crystal cell is usually disposed two polarizing plates. The polarizing plate protective film of the present invention may be used as a protective film for either one of two polarizing plates but is preferably used, out of two protective films of respective polarizing plates, as a protective film disposed outside of the liquid crystal cell relative to the polarizer.

In particular, the polarizing plate protective film of the present invention is preferably disposed as a viewing-side protective film of a viewing-side polarizing plate out of two polarizing plates.

It is also a preferred embodiment that after the polarizing plate protective film of the present invention is disposed as a viewing-side protective film of a viewing-side polarizing plate out of two polarizing plates, the polarizing plate protective film of the present invention is further disposed for a backlight-side protective film of a backlight-side polarizing plate to thereby restrain the shrinkage of the polarizer contained in two polarizing plates and prevent the warpage of the panel.

### (Types of Liquid Crystal Display Device)

The film of the present invention can be used in liquid crystal cells of various modes. Various display modes such as TN (Twisted Nematic), IPS (In-Plane Switching), FLC (Fenoelectric Liquid Crystal), AFLC (Anti-Ferroelectric Liquid Crystal), OCB (Optically Compensatory Bend), STN (Super Twisted Nematic), VA (Vertically Aligned), ECB (Electrically Controlled Birefringence), and HAN (Hybrid Aligned Nematic) have been proposed. Furthermore, a display mode obtained by alignment division of the display mode above has also been proposed. The polarizing plate protective film of the present invention is effective in a liquid crystal display device of any display mode and is also effective in a liquid crystal display device of any of a transmission type, a reflection type and a transflective type.

The present invention is described in greater detail below by referring to Examples. The materials, reagents, amounts and ratios of substances, operations, etc. described in the following Examples can be appropriately changed or modified without departing from the purport of the present invention. Accordingly, the present invention is not limited or restricted to these Examples.

### [Preparation of Low Moisture-Permeable Layer-Forming Composition]

A low moisture-permeable layer-forming composition was prepared as follows.

### (Formulation of Low Moisture-Permeable Layer-Forming Composition BL-1)

| | | |
|---|---|---|
| A-DCP | 87.0 | parts by mass |
| Compound B33 | 10.0 | parts by mass |
| Irgacure 907 | 3.0 | parts by mass |
| SP-13 | 0.04 | parts by mass |
| MEK (methyl ethyl ketone) | 36.7 | parts by mass |
| MIBK (methyl isobutyl ketone) | 85.6 | parts by mass |

Low Moisture-Permeable Layer-Forming Compositions BL-2 to BL-17 were prepared in the same manner as Low Moisture-Permeable Layer-Forming Composition BL-1. The ratio in each composition is shown in Table 1. In Table 1, the mass ratio of solid content of each component contained is shown. The solid matter as used herein means the composition excluding the solvent (in BL-1, methyl ethyl ketone and methyl isobutyl ketone). Incidentally, in the Table below, the unit of the numerical value indicating the formulation is all the parts by mass.

The materials used are as follows.

A-DCP: Tricyclodecanedimethanol diacrylate [produced by Shin-Nakamura Chemical Co., Ltd.]; A-DCP corresponds to Compound M-5.

DCP: Tricyclodecanedimethanol dimethacrylate [produced by Shin-Nakamura Chemical Co., Ltd.]; DCP corresponds to Compound M-4.

AA-BPEF: 9,9-Bis[4-(2-acryloyloxyethoxyl)phenyl]fluorene [produced by Shin-Nakamura Chemical Co., Ltd.].

ADDA: 1,3-Adamantane diacrylate (produced by Mitsubishi Gas Chemical Company, Inc.): ADDA corresponds to Compound M-7.

PET30: A mixture of pentaerythritol tetraacrylate and pentaerythritol triacrylate [produced by Nippon Kayaku Co., Ltd.].

Irgacure 907: Polymerization initiator [produced by BASF].

SP-13 (Leveling agent having a structure shown below; in the formula, the composition ratio 60:40 is molar ratio):

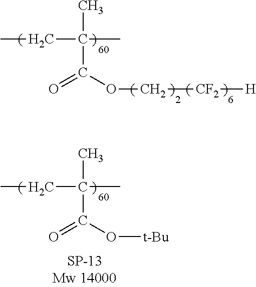

B5 (2,6-Diphenylphenol): a reagent produced by Tokyo Chemical Industry Co., Ltd. was used.

B15 (2,6-Dicyclohexylcyclohexanol): synthesized from B5 by hydrogenation.

B23 (Triphenylmethanol): a reagent produced by Tokyo Chemical Industry Co., Ltd. was used.

B32 (Dicyclohexylmethyl methanol): synthesized from diphenyl ethanol [a reagent produced by Junsei Chemical Co., Ltd.] by hydrogenation.

B33 (Tricyclohexylmethanol): a reagent produced by SIGMA-ALDRICH was used.

B34 (1,1,2-Tricyclohexylethanol): synthesized from 1,1,2-triphenylethanol [a reagent produced by Service Chemical Inc.] by hydrogenation.

### <Production of Polarizing Plate Protective Film 101>

As the substrate film, FUJITAC TD40 (produced by Fujifilm Corporation, width: 1,340 mm, thickness: 40 μm) was unwound from the roll form, then coated with Low Moisture-Permeable Layer-Forming Composition BL-1 by a die coating method using the slot die described in Example 1 of JP-A-2006-122889 under the condition of a conveying speed of 30 m/min, and dried at 60° C. for 150 seconds. Thereafter, the coated layer was further cured by the irradiation with an ultraviolet ray at an illuminance of 400 mW/cm² and an irradiation dose of 150 mJ/cm² by using an air-cooled metal halide lamp with an output of 160 W/cm (manufactured by Eye Graphics Co., Ltd.) at an oxygen concentration of about 0.1 vol % while purging with nitrogen, thereby forming a low moisture-permeable layer, and the film was taken up. The coated amount was adjusted such that the film thickness of the low moisture-permeable layer becomes 10 μM. In this way, Polarizing Plate Protective Film 101 composed of Low Moisture-Permeable Layer-Forming Composition BL-1 was obtained.

### <Production of Polarizing Plate Protective Films 102 to 117>

Polarizing Plate Protective Films 102 to 117 were produced in the same manner as Polarizing Plate Protective Film 101 except that in the production of Polarizing Plate Protective Film 101, Low Moisture-Permeable Layer-Forming Composition BL-1 was replaced by BL-2 to BL-17.

### [Evaluation of Polarizing Plate Protective Film]

With respect to the polarizing plate protective film produced of each of Examples and Comparative Examples, the film thickness was measured, and the following physical properties were measured and evaluated. The results are shown in Table 1 below.

(1) Moisture Permeability (moisture permeability at 40° C. and relative humidity of 90%)

The polarizing plate protective film sample in each of Examples and Comparative Examples was cut in a circle with a diameter of 70 mm, then humidity-conditioned at 40° C. and a relative humidity of 90% for 24 hours, and then measured by the method described in JIS Z-0208.

The moisture permeability of the low moisture-permeable layer can be calculated using the following formula (1) from the moisture permeability of the substrate film and the moisture permeability of the polarizing plate protective film after measuring the moisture permeability of the substrate film of each polarizing plate protective film:

1/J_{f}=1/Jₛ+1/J_{b} Formula (1)

wherein J_{f} represents the moisture permeability of the polarizing plate protective film, J, represents the moisture permeability of the substrate film, and J_{b} represents the moisture permeability of the low moisture-permeable layer.

TABLE 1

| | Example/Comparative Example | | | | | | | | | |
|---|---|---|---|---|---|---|---|---|---|---|
| | Polarizing plate protective film | Example | Example | Example | Example | Example | Example | Example | Example | Example |
| | sample No. | 101 | 102 | 103 | 104 | 105 | 106 | 107 | 108 | 109 |
| | Low moisture-permeable layer- | BL-1 | BL-2 | BL-3 | BL-4 | BL-5 | BL-6 | BL-7 | BL-8 | BL-9 |
| | forming composition | | | | | | | | | |
| Alicyclic | A-DCP | 87.0 | 94.5 | 92.0 | 77.0 | 67.0 | 50.0 | 87.0 | 87.0 | 87.0 |
| compound or | DCP | | | | | | | | | |
| fluorene | AA-BPEF | | | | | | | | | |
| compound | ADDA | | | | | | | | | |
| Compound B | B33 | 10.0 | 2.5 | 5.0 | 20.0 | 30.0 | 30.0 | | | |
| | B34 | | | | | | | 10.0 | | |
| | B32 | | | | | | | | 10.0 | |
| | B23 | | | | | | | | | 10.0 |
| | B5 | | | | | | | | | |
| | B15 | | | | | | | | | |
| | PET30 | | | | | | 17.0 | | | |
| | Irgacure 907 | 3.0 | 3.0 | 3.0 | 3.0 | 3.0 | 3.0 | 3.0 | 3.0 | 3.0 |
| | SP-13 | 0.04 | 0.04 | 0.04 | 0.04 | 0.04 | 0.04 | 0.04 | 0.04 | 0.04 |
| Evaluation | Moisture permeability of polarizing | 62 | 80 | 73 | 41 | 41 | 69 | 66 | 69 | 77 |
| results | plate protective film (g/m² · day) | | | | | | | | | |

| | Example/Comparative Example | | | | | | Comparative | Comparative | Comparative |
|---|---|---|---|---|---|---|---|---|---|
| | Polarizing plate protective film | Example | Example | Example | Example | Example | Example | Example | Example |
| | sample No. | 110 | 111 | 112 | 113 | 114 | 115 | 116 | 117 |
| | Low moisture-permeable layer- | | | | | | | | |
| | forming composition | BL-10 | BL-11 | BL-12 | BL-13 | BL-14 | BL-15 | BL-16 | BL-17 |
| Alicyclic | A-DCP | 87.0 | 87.0 | 43.5 | | | 97.0 | 46.0 | |
| compound or | DCP | | | 43.5 | | 43.5 | | | |
| fluorene | AA-BPEF | | | | 87.0 | | | | |
| compound | ADDA | | | | | 43.5 | | | |
| Compound B | B33 | | | 10.0 | 10.0 | 10.0 | | 5.0 | 5.0 |
| | B34 | | | | | | | | |
| | B32 | | | | | | | | |
| | B23 | | | | | | | | |
| | B5 | 10.0 | | | | | | | |
| | B15 | | 10.0 | | | | | | |
| | PET30 | | | | | | | 46.0 | 92.0 |
| | Irgacure 907 | 3.0 | 3.0 | 3.0 | 3.0 | 3.0 | 3.0 | 3.0 | 3.0 |
| | SP-13 | 0.04 | 0.04 | 0.04 | 0.04 | 0.04 | 0.04 | 0.04 | 0.04 |
| Evaluation | Moisture permeability of polarizing | 69 | 66 | 59 | 63 | 59 | 91 | 144 | 190 |
| results | plate protective film (g/m² · day) | | | | | | | | |

The results shown in Table 1 reveal the followings.

1. The polarizing plate protective film of Examples having a low moisture-permeable layer formed by curing a curable composition containing, in a specific amount, (A) at least either a compound having a cyclic aliphatic hydrocarbon group and an ethylenically unsaturated double bond or a compound having a fluorene ring and an ethylenically unsaturated double bond, and containing, in a specific amount, (B) a compound having, in the molecule, at least either a total of 2 to 4 benzene rings or a total of 2 to 4 cyclohexane rings and at least either a total of 1 to 2 hydroxy groups or a total of 1 to 2 carboxy groups, is low in the moisture permeability and excellent, compared with the polarizing plate protective film of Comparative Examples having a low moisture-permeable layer formed by curing a curable composition containing only either one of (A) and (B).

A case where a hardcoat layer is stacked on the low moisture-permeable layer of the polarizing plate protective film produced above is described below.

### <Production of Optical Film 201>

### [Preparation of Hardcoat Layer-Forming Composition]

A hardcoat layer-forming composition was prepared as follows.

### (Formulation of Hardcoat Layer-Forming Composition HCL-1)

| | | |
|---|---|---|
| PET30 | 97.0 | parts by mass |
| Irgacure 907 | 3.0 | parts by mass |
| SP-13 | 0.04 | parts by mass |
| MEK | 81.8 | parts by mass |

### (Coating of Hardcoat Layer)

Rolled Polarizing Plate Protective Film 101 produced above was unwound from the roll form, and the surface where the low moisture-permeable layer was stacked was coated with Hardcoat Layer-Forming Composition HCL-1 by a die coating method using the slot die described in Example 1 of JP-A-2006-122889 under the condition of a conveying speed of 30 m/min and dried at 60° C. for 150 seconds. Thereafter, the coated layer was further cured by the irradiation with an ultraviolet ray at an illuminance of 400 mW/cm² and an irradiation dose of 300 mJ/cm² by using an air-cooled metal halide lamp with an output of 160 W/cm (manufactured by Eye Graphics Co., Ltd.) at an oxygen concentration of about 0.1 vol % while purging with nitrogen, thereby forming a hardcoat layer, and the film was taken up. The coated amount was adjusted such that the film thickness of the hardcoat layer becomes 6 μm. The obtained film was designated as Optical Film 201 of Example.

### <Production of Optical Film 215>

Optical Film 215 of Comparative Example was produced in the same manner except that in the production of Optical Film 201, Polarizing Plate Protective Film 101 was replaced by Polarizing Plate Protective Film 115.

### [Measurement of Optical Film]

With respect to the optical films produced of Example and Comparative Example, the film thickness was measured, and the following physical properties were measured and evaluated. The results are shown in Table 2 below. Incidentally, the moisture permeability was measured by the same method as in Polarizing Plate Protective Film 101.

### (Pencil Hardness Evaluation)

The pencil hardness evaluation described in JIS K-5400 was performed as an index of scratch resistance. The optical film was humidity-conditioned at a temperature of 25° C. and a humidity of 60% RH for 2 hours, and then the pencil hardness evaluation of n=5 was performed under a load of 4.9N by using 2H to 5H test pencils specified in JIS S-6006 on the surface where the hardcoat layer was stacked. The hardness was rated according to the following criteria and out of test pencils allowing for evaluation results, the highest pencil hardness was used as the evaluation value.

OK: 3 or more of no scratch in evaluation of n=5 and there is no problem in practice.

NG: 2 or less of no scratch in evaluation of n=5 and there is a problem in practice.

TABLE 2

| | | Example/ | |
|---|---|---|---|
| | | Comparative Example | |
| | | | Comparative |
| | | Example | Example |
| | Optical film sample No. | 201 | 215 |
| | Low moisture-permeable | BL-1 | BL-15 |
| | layer-forming composition | | |
| Alicyclic | A-DCP | 87.0 | 97.0 |
| compound | | | |
| Compound B | B33 | 10.0 | |
| | Irgacure 907 | 3.0 | 3.0 |
| | SP-13 | 0.04 | 0.04 |
| Evaluation | Moisture permeability of | 58 | 83 |
| results | optical film (g/m² · day) | | |
| | Pencil hardness | 3H | 3H |

The embodiment where the low moisture-permeable layer further contains (C) a rosin compound is described below.

<Substrate Film (A−1): Production of Cellulose Acylate Film with Adherence Layer>

### (Formulation of Adherence Layer-forming Coating Solution AL-1)

| | | |
|---|---|---|
| A-TMMT | 3.39 | parts by mass |
| Irgacure 907 | 0.11 | parts by mass |
| SP-13 | 0.0007 | parts by mass |
| MEK | 18.17 | parts by mass |
| MIBK (methyl isobutyl ketone) | 77.20 | parts by mass |

The material used is as follows.

A-TMMT: Pentaerythritol tetraacrylate [produced by Shin-Nakamura Chemical Co., Ltd.].

FUJITAC TD40 (produced by Fujifilm Corporation, width: 1,340 mm, thickness: 40 μm) was unwound from the roll form, then coated with Adherence Layer-Forming Composition AL-1 by a die coating method using the slot die described in Example 1 of JP-A-2006-122889 under the condition of a conveying speed of 30 m/min, and dried at 60° C. for 150 seconds. Thereafter, the coated layer was further cured by the irradiation with an ultraviolet ray at an illuminance of 400 mW/cm² and an irradiation dose of 60 mJ/cm² by using an air-cooled metal halide lamp with an output of 160 W/cm (manufactured by Eye Graphics Co., Ltd.) at an oxygen concentration of about 0.1% while purging with nitrogen, thereby forming an adherence layer, and the film was taken up. The coated amount was adjusted such that the film thickness of the adherence layer becomes 0.3 μm. The obtained film was designated as Substrate Film (A−1).

### [Preparation of Low Moisture-Permeable Layer-Forming Composition]

Low Moisture-Permeable Layer-Forming Compositions BL-21 to BL-27 were prepared to give a ratio in the composition shown in Table 3 below. In Table 3, the mass ratio of each component contained to the total solid content is shown.

The materials used are as follows (materials already cited are omitted).

PINECRYSTAL KR614 (trade name, ultra-light color rosin, produced by Arakawa Chemical Industries, Ltd., acid value: 175 mgKOH/g, softening point: 88° C.).

PINECRYSTAL KR85 (trade name, ultra-light color rosin, produced by Arakawa Chemical Industries, Ltd., acid value: 170 mgKOH/g, softening point: 83° C.).

PINECRYSTAL KE604 (trade name, acid-modified ultra-light color rosin, produced by Arakawa Chemical Industries, Ltd., acid value: 235 mgKOH/g, softening point: 129° C.).

### <Production of Polarizing Plate Protective Film 301>

Substrate Film (A−1) was unwound from the roll form, and the surface where the adherence layer was stacked was coated with Low Moisture-Permeable Layer-Forming Composition BL-21 by a die coating method using the slot die described in Example 1 of JP-A-2006-122889 under the condition of a conveying speed of 30 m/min and dried at 60° C. for 150 seconds. Thereafter, the coated layer was further cured by the irradiation with an ultraviolet ray at an illuminance of 400 mW/cm² and an irradiation dose of 150 mJ/cm² by using an air-cooled metal halide lamp with an output of 160 W/cm (manufactured by Eye Graphics Co., Ltd.) at an oxygen concentration of about 0.1 vol % while purging with nitrogen, thereby forming a low moisture-permeable layer, and the film was taken up. The coated amount was adjusted such that the film thickness of the low moisture-permeable layer becomes 10 In this way, Polarizing Plate Protective Film 301 having a low moisture-permeable layer composed of Low Moisture-Permeable Layer-Forming Composition BL-21 was obtained.

### <Production of Polarizing Plate Protective Films 302 to 307>

Polarizing Plate Protective Films 302 to 307 were produced in the same manner as Polarizing Plate Protective Film 301 except that in the production of Polarizing Plate Protective Film 301, Low Moisture-Permeable Layer-Forming Composition BL-21 was replaced by BL-22 to BL-27.

Polarizing Plate Protective Films 301 to 307 produced above were evaluated by the same method as in Polarizing Plate Protective Film 101. The results are shown in Table 3.

TABLE 3

| | Example/Comparative Example | | | | | | | Comparative |
|---|---|---|---|---|---|---|---|---|
| | Polarizing plate protective film | Example | Example | Example | Example | Example | Example | Example |
| | sample No. | 301 | 302 | 303 | 304 | 305 | 306 | 307 |
| | Low moisture-permeable layer- | BL-21 | BL-22 | BL-23 | BL-24 | BL-25 | BL-26 | BL-27 |
| | forming composition | | | | | | | |
| Alicyclic | A-DCP | 41.0 | 38.5 | 38.5 | 38.5 | 82.0 | 43.5 | 48.5 |
| compound or | DCP | 41.0 | 38.5 | 38.5 | 38.5 | | 43.5 | 48.5 |
| fluorene compound | | | | | | | | |
| Compound B | B33 | 10.0 | 10.0 | 10.0 | 10.0 | 10.0 | 10.0 | |
| Rosin compound | PINECRYSTAL KR614 | 5.0 | 10.0 | | | 5.0 | | |
| | PINECRYSTAL KR85 | | | 10.0 | | | | |
| | PINECRYSTAL KE604 | | | | 10.0 | | | |
| Others | Irgacure 907 | 3.0 | 3.0 | 3.0 | 3.0 | 3.0 | 3.0 | 3.0 |
| | SP-13 | 0.04 | 0.04 | 0.04 | 0.04 | 0.04 | 0.04 | 0.04 |
| Evaluation results | Moisture permeability of polarizing | 58 | 50 | 54 | 58 | 62 | 59 | 91 |
| | plate protective film (g/m² · day) | | | | | | | |

The results shown in Table 3 reveal the followings.

1. The polarizing plate protective film having a low moisture-permeable layer formed by curing a curable composition containing a specific amount of the compound (A) and a specific amount of the compound (B) and further containing (C) a rosin compound is more reduced in the moisture permeability and excellent, compared with the film not containing (C) a rosin compound.

An example of the optical film having an antiglare layer on the low moisture-permeable layer of the polarizing plate protective film produced above is described below.

### <Production of Optical Film 401>

### [Preparation of Antiglare Layer-Forming Composition]

An antiglare layer-forming composition was prepared as follows.

### (Formulation of Antiglare Layer-Forming Composition AGL-1)

| | | |
|---|---|---|
| Smectite (LUCENTITE STN, produced by CO- | 1.00 | parts by mass |
| OP Chemical Co., Ltd.) | | |
| Crosslinked acryl-styrene particle (average | 8.00 | parts by mass |
| particle diameter: 2.5 (μm, refractive index: | | |
| 1.52) | | |
| Acrylate monomer (NK Ester A9550, | 87.85 | parts by mass |
| produced by Shin-Nakamura | | |
| Chemical Co., Ltd.) | | |
| Irgacure 907 | 3.00 | parts by mass |
| Leveling agent (SP-13) | 0.15 | parts by mass |
| MIBK (methyl isobutyl ketone) | 133.50 | parts by mass |
| MEK (methyl ethyl ketone) | 16.50 | parts by mass |

The solid content concentration of Antiglare Layer-Forming Composition AGL-1 was 40 mass %. Incidentally, each of the resin particle and smectite was added in a dispersed state.

### (Coating of Antiglare Layer)

Rolled Polarizing Plate Protective Film 301 produced above was unwound from the roll form, and the surface where the low moisture-permeable layer was stacked was coated with Composition (AGL-1) for antiglare hardcoat layer by a die coating method using the slot die described in Example 1 of JP-A-2006-122889 under the condition of a conveying speed of 30 m/min and dried at 60° C. for 150 seconds. Thereafter, the coated layer was further cured by the irradiation with an ultraviolet ray at an illuminance of 400 mW/cm² and an irradiation dose of 180 mJ/cm² by using an air-cooled metal halide lamp with an output of 160 W/cm (manufactured by Eye Graphics Co., Ltd.) at an oxygen concentration of about 0.1 vol % while purging with nitrogen, thereby forming an antiglare layer, and the film was taken up. The coated amount was adjusted such that the film thickness of the antiglare hardcoat layer becomes 6 μm.

The obtained optical film was designated as Optical Film 401.

### <Production of Optical Film 407>

Optical Film 407 of Comparative Example was produced in the same manner s Optical Film 401 except that in the production of Optical Film 401, Polarizing Plate Protective Film 301 was replaced by Polarizing Plate Protective Film 307.

Optical Films 401 and 407 produced above were evaluated by the same method as in Optical Film 201.

The results are shown in Table 4.

The back surface (the surface where the antiglare layer was not stacked) of each of Optical Films 401 and 407 was blacked out with a black marker, a bare fluorescent lamp (8,000 cd (candela)/m²) without louver was projected on the surface where the antiglare layer was stacked, and whether the contour of the fluorescent lamp was blurred or not was confirmed with an eye, thereby evaluating the antiglare property, as a result, both films had an antiglare property. However, the moisture permeability was greatly different therebetween, and Optical Film 401 of the present invention was superior.

TABLE 4

| | | Example/ | |
|---|---|---|---|
| | | Comparative Example | |
| | | | Comparative |
| | | Example | Example |
| | Optical film sample No. | 401 | 407 |
| | Low moisture-permeable | BL-21 | BL-27 |
| | layer-forming | | |
| | composition | | |
| Alicyclic compound | A-DCP | 41.0 | 48.5 |
| or fluorene | DCP | 41.0 | 48.5 |
| compound | | | |
| Compound B | B33 | 10.0 | |
| Rosin compound | PINECRYSTAL KR614 | 5.0 | |
| | PINECRYSTAL KR85 | | |
| | PINECRYSTAL KE604 | | |
| Others | Irgacure 907 | 3.0 | 3.0 |
| | SP-13 | 0.04 | 0.04 |
| Evaluation | Moisture permeability of | 58 | 91 |
| results | optical film (g/m² · day) | | |
| | Pencil hardness | 2H | 2H |

The present invention was described in detail with reference to specific embodiments, but it will be apparent to those of ordinary skill in the art that various changes and modifications can be carried out without departing from the spirit and scope of the present invention.

This application is based on Japanese Patent Application (Patent Application No. 2013-212190) filed on Oct. 9, 2013 and Japanese Patent Application (Patent Application No. 2014-168615) filed on Aug. 21, 2014, the contents of which are incorporated herein by reference.

1. A polarizing plate protective film having, on a substrate film, a layer formed by curing a curable composition containing, setting a total solid content of the curable composition to 100 mass %, from 50 to 99 mass % of the following (A) and from 1 to 30 mass % of the following (B) based on the total solid content:
(A) at least either a compound having a cyclic aliphatic hydrocarbon group and an ethylenically unsaturated double bond or a compound having a fluorene ring and an ethylenically unsaturated double bond; and
(B) a compound having, in the molecule, at least one of a benzene ring and a cyclohexane ring, and at least one of a hydroxyl group and a carboxy group,
wherein a total number of the at least one of a benzene ring and a cyclohexane ring is 2 to 4, and a total number of the at least one of a hydroxyl group and a carboxy group is 1 to 2.

2. The polarizing plate protective film as claimed in claim 1,
wherein the (B) is a compound represented by any one of the following formulae (B-1) to (B-4): 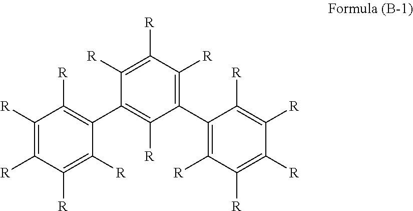
wherein in formula (B-1),
a total of 1 to 2 R out of a plurality of R represent at least either a hydroxy group or a carboxy group and each of other R independently represents a hydrogen atom or an alkyl group having a carbon number of 1 to 4: 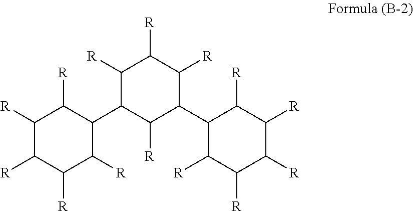
wherein in formula (B-2),
a total of 1 to 2 R out of a plurality of R represent at least either a hydroxy group or a carboxy group and each of other R independently represents a hydrogen atom or an alkyl group having a carbon number of 1 to 4: 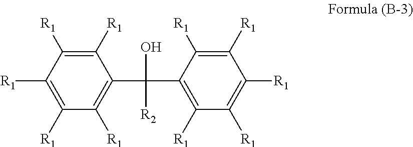
wherein in formula (B-3),
R₂ represents a hydrogen atom, an alkyl group having a carbon number of 1 to 4, or a group represented by the following formula (S1) or (S2); in formula (B-3) and the following formulae (S1) and (S2), each R₁ independently represents a hydrogen atom or an alkyl group having a carbon number of 1 to 4; and in the following formulae (S1) and (S2), * represents a bonding site to the carbon atom to which R₂ is bonded: 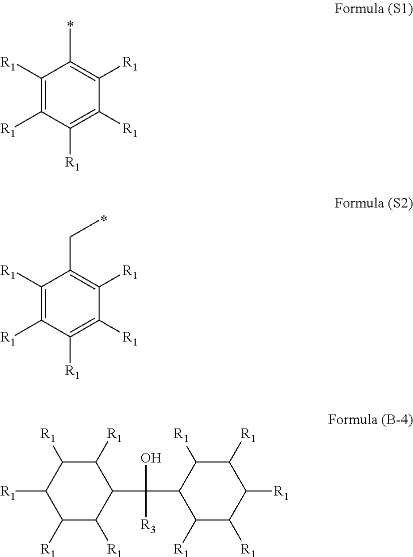
wherein in formula (B-4),
R₃ represents a hydrogen atom, an alkyl group having a carbon number of 1 to 4, or a group represented by the following formula (S3) or (S4); in formula (B-4) and the following formulae (S3) and (S4), each R₁ independently represents a hydrogen atom or an alkyl group having a carbon number of 1 to 4; and in the following formulae (S3) and (S4), * represents a bonding site to the carbon atom to which R₃ is bonded:

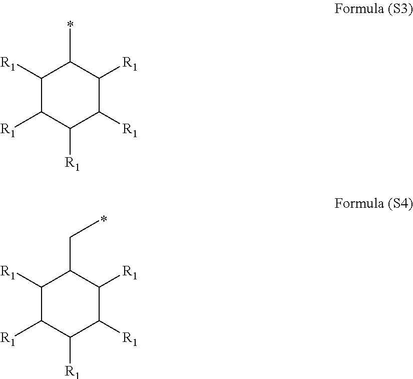

3. The polarizing plate protective film as claimed in claim 1,
wherein the cyclic aliphatic hydrocarbon group in (A) is a group represented by the following formula (I): 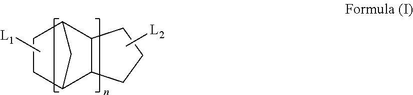
wherein in formula (I),
each of L₁ and L₂ independently represents a divalent or higher valent linking group, and n represents an integer of 1 to 3.

4. The polarizing plate protective film as claimed in claim 1,
wherein setting a total solid content of the curable composition to 100 mass %, the composition contains from 1 to 40 mass % of (C) a rosin compound based on the total solid content.

5. The polarizing plate protective film as claimed in claim 4,
wherein the rosin compound is one or more rosin compounds selected from rosin, a hydrogenated rosin, an acid-modified rosin and an esterified rosin.

6. The polarizing plate protective film as claimed in claim 1,
wherein the substrate film is a cellulose acylate film.

7. The polarizing plate protective film as claimed in claim 1, further having a hardcoat layer on the layer formed by curing a curable composition containing (A) and (B).

8. A method for producing a polarizing plate protective film, comprising:
a step of forming, on a substrate film, a layer by curing a curable composition containing, setting a total solid content of the curable composition to 100 mass %, from 50 to 99 mass % of the following (A) and from 1 to 30 mass % of the following (B) based on the total solid content:
(A) at least either a compound having a cyclic aliphatic hydrocarbon group and an ethylenically unsaturated double bond or a compound having a fluorene ring and an ethylenically unsaturated double bond; and
(B) a compound having, in the molecule, at least one of a benzene ring and a cyclohexane ring, and at least one of a hydroxyl group and a carboxy group,
wherein a total number of the at least one of a benzene ring and a cyclohexane ring is 2 to 4, and a total number of the at least one of a hydroxyl group and a carboxy group is 1 to 2.

9. A polarizing plate comprising a polarizer and, as a protective film of the polarizer, at least one polarizing plate protective film claimed in claim 7.

10. A liquid crystal display device comprising:
a liquid crystal cell and
the polarizing plate claimed in claim 9 disposed on at least one surface of the liquid crystal phase,
wherein the polarizing plate protective film is disposed on the outermost surface.
